(19) United States
(12) Patent Application Publication
(10) Pub. No.: US 2026/0360340 A1
(43) Pub. Date: Nov. 12, 2026

(54) USB MIDI ELECTRIC GUITAR DIGITAL CONTROLS

(71) Applicant: Cherrystone Designs, LLC, Beaverton, OR (US)

(72) Inventor: Ronald K. Anderson, Beaverton, OR (US)

(21) Appl. No.: 19/422,211

(22) Filed: Dec. 16, 2025

Related U.S. Application Data
(60) Provisional application No. 63/800,844, filed on May 6, 2025.

(51) Int. Cl. G10H 1/00; G10H 1/18; G10H 1/34; G10H 3/14; G10H 3/18

(52) U.S. Cl. CPC G10H 1/0066; G10H 1/0008; G10H 1/18; G10H 1/34; G10H 3/143; G10H 3/181; G10H 3/188; G10H 2220/265; G10H 2220/505; G10H 2220/525; G10H 2240/285; G10H 2240/311

(57) ABSTRACT

The control of the voicing of electric guitars has not changed substantively since their inception in the mid-20th century. Although there have been efforts to add proprietary digital control of a small set of internally generated voices, what has been missing is a general-purpose user-programmable interface that can link to the growing market of MIDI-controllable software models using the same classic controls familiar to electric guitar players: rotary adjustment knobs and 5-way blade-switch selectors. The solutions herein replace these classic controls with similar but flexible devices which can address a vast palette of preprogrammed effects chains, equalization (EQ) curves, environmental acoustics, and other audio modification elements available in the vast and growing catalogue of 3rd party software models of real or synthetic audio functions.

### CROSS-REFERENCE TO RELATED APPLICATIONS

This application claims the benefit of U.S. provisional patent application No. 63/800,844, filed May 6, 2025, titled “USB MIDI ELECTRIC GUITAR DIGITAL CONTROLS,” and incorporated herein by reference

### BACKGROUND

Electric guitars have been popular musical instruments for many years due to their ability to create many types of sounds. Moreover, with the introduction of the Music Instrument Digital Interface (MIDI) protocol, many new features are possible. MIDI allows electronic musical instruments, including guitars, to communicate with each other and with computers, enabling precise control, sequencing, and synchronization of sounds.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts an example block diagram of an embedded system 100, in accordance with various embodiments.

FIGS. 2A and 2B depict first and second parts, respectively, of an example detailed block diagram of a hardware system 200 which is an embodiment of the system 100 of FIG. 1, in accordance with various embodiments.

FIG. 3 depicts a circuit 300 depicting an example comparative use of 5-way switch and tone selector, in accordance with various embodiments.

FIG. 4 depicts an example circuit 400 which provides a novel use of a 5-way switch and includes a digital position sensor, in accordance with various embodiments.

FIG. 5 depicts an example circuit 500 which provides a comparative use of 5-way switch and includes a pickups selector, in accordance with various embodiments.

FIG. 6 depicts an example circuit 600 which provides a novel method to improve pickup noise rejection, in accordance with various embodiments.

FIG. 7 depicts an example classic representation 700 of 5-way switch as a sequential Finite State Machine (FSM), in accordance with various embodiments.

FIG. 8 depicts a flowchart 800 of an example generalized method of determining a switch position from the state of Sequential Finite State Machine (SFSM) bit values, in accordance with various embodiments.

FIG. 9 depicts a flowchart of an example system control method, simplified, in accordance with various embodiments.

FIG. 10 depicts a flowchart of an example generalized method of handling interrupts, in accordance with various embodiments.

FIG. 11A depicts a flowchart of an example method of handling pushbutton-initiated interrupts, for a first pushbutton Interrupt Service Routine (ISR), in accordance with various embodiments.

FIG. 11B depicts a flowchart of an example method of handling pushbutton initiated interrupts, for a second pushbutton Interrupt Service Routine (ISR), in accordance with various embodiments.

FIG. 12A depicts a flowchart of an example method of handling rotary knob-initiated interrupts, for a first rotary knob ISR, in accordance with various embodiments.

FIG. 12B depicts a flowchart of an example method of handling rotary knob-initiated interrupts, for a second rotary knob ISR, in accordance with various embodiments.

FIG. 13A depicts a flowchart of an example method depicting a novel behavior of pushbuttons, for a first pushbutton action, in accordance with various embodiments.

FIG. 13B depicts a flowchart of an example method depicting a novel behavior of pushbuttons, for a second pushbutton action, in accordance with various embodiments.

FIG. 14 depicts a flowchart of an example method depicting a novel rotary knob behavior, for a rotary knob clockwise (CW) action and a rotary knob counterclockwise (CCW) action, in accordance with various embodiments.

FIG. 15A depicts a flowchart of an example method depicting another novel Rotary Knob Behavior, for a rotary knob clockwise (CW) action, in accordance with various embodiments.

FIG. 15B depicts a flowchart of an example method depicting another novel Rotary Knob Behavior, for a rotary knob counterclockwise (CCW) action, in accordance with various embodiments.

FIG. 16 depicts an example view of a parts map for a guitar 1600, in accordance with various embodiments.

FIG. 17A depicts an example full module printed circuit board (PCB) and connector map, with different elements of a full-featured module noted by dotted regions, in accordance with various embodiments.

FIG. 17B depicts an example assembled functional module 1790 comprising a number of interconnected PCBs and third-party components, in accordance with various embodiments.

FIG. 18A depicts an example isometric view of an assembled functional module 1800 comprising a number of interconnected PCBs but without third-party components, in accordance with various embodiments.

FIG. 18B depicts an example side view of the module 1800 of FIG. 18A, in accordance with various embodiments.

FIG. 18C depicts an example end view of the module 1800 of FIG. 18A, in accordance with various embodiments.

FIG. 18D depicts an example top view of the module 1800 of FIG. 18A, in accordance with various embodiments.

FIG. 19 depicts an example of PCBs in a kit 1900, including CD_0021, CD_0091, CD_0100, etc., in accordance with various embodiments.

FIG. 20 depicts an example installation 2000 of the circuit 1800 described herein in a guitar body with a see-through pick guard 2010, in accordance with various embodiments.

FIG. 21 depicts an example portion of a guitar 2110 with a visual state indicator 2100, indicating a state of the circuit of FIG. 20, in accordance with various embodiments.

FIG. 22 depicts an example block diagram of a complete system 2200, in accordance with various embodiments.

FIG. 23 depicts an example table of pre-DSP voices, in accordance with various embodiments.

### DETAILED DESCRIPTION

As mentioned at the outset, the MIDI protocol enables many new features for guitars. In one approach, the guitar is connected to a MIDI footswitch which can be operated by the musician to send MIDI messages to MIDI-compatible devices. For example, the MIDI footswitch can send MIDI Program Change (PC) and Continuous Controller (CC) messages to an external digital effects processor, among other functions. A MIDI PC message is a type of MIDI message that tells a receiving device to change to a different sound, preset, or patch. It is essentially a command that instructs the device to select a specific sound from its internal library. However, the MIDI footswitch can be bulky and heavy, among other disadvantages.

The solutions provided herein address the above and other disadvantages. In one aspect, the solutions provide an embedded microcontroller to achieve the same functionality as the MIDI footswitch but at a small fraction of the volume and weight. Many other advantages can be realized as well.

An example implementation involves a Stratocaster®-type guitar which has three pickups: bridge, middle and neck and two tone control knobs, one for the bridge pickup and one for the neck pickup. An additional volume knob is also used, along with a five-way pickup selector switch. The selector switch allows the user to select 1. bridge pickup only, 2. Bridge and middle pickups (parallel), 3. middle pickup only, 4. middle and neck pickups (parallel), and 5. neck pickup only. The guitar also typically has a jack to connect the guitar to an amplifier or other audio equipment. The jack can be a standard ¼-inch, 2-conductor, mono output jack, for instance.

An example of the 5-way switch is the 51993 model switch produced by Oak Grigsby, Electroswitch Electronic Products, Raleigh, NC. Although, other suppliers and other types of switches can be used.

In an example implementation, the two stock tone controls were replaced with digital output rotary knobs. The tone controls comprise the resistive elements of a single-pole resistor-capacitor (RC) low-pass filters that attenuate high frequencies in certain positions of the stock 5-way switch. The rotary knobs thus operate differently. Instead of holding an intrinsic static value, they typically only register change. Rotation and direction of rotation can be detected, and the value being adjusted is maintained in a digital circuit with a memory. This is served by a microcontroller unit (MCU). The scope and range of parameters that a digital rotary knob can control greatly exceeds that of an RC tone control.

In an example implementation, the rotary knobs have embedded red-green-blue (RGB) light-emitting diodes (LEDs) to illuminate a translucent shaft which can be used as a visual indicator of the state or functionality of the system. Since the shaft can also function as a pushbutton, an encoder can change the feature that it controls. A benefit is that instead of simply rolling off certain high frequencies, it can now choose between entire equalization (EQ) curves or entire effects chains. The value proposition of the increased functionality is therefore significant.

Rolling off high frequencies on a guitar refers to, e.g., attenuating the upper end of the guitar's frequency response, often above 8 kHz, to reduce harshness, sizzle, or unwanted high-frequency noise. This can be achieved through equalization (EQ) techniques, such as using a low-pass filter, or by adjusting the tone knob on the guitar.

The solutions further repurpose half of the stock 5-way switch as another MIDI control element, as well as provide a way to enable or disable that feature on demand. Because the position of the 5-way switch is now known by the processor, it could correct a problem plaguing the popular 70-year-old guitar architecture: how to eliminate the hum in all five switch positions without sacrificing the organic highly-valued voicing and possibly serendipitous hum-cancelling effect of two different single-coil pickups with opposite polarities, while allowing any of the three pickups to be configured by the user either as hum-cancelling or a classic single-coil.

Allowing the 5-way switch to be a factor in selecting the MIDI Program Change message allowed the entire effects chain to be unique for that pickup selection, whether subtle or in sharp contrast with its neighbors. Allowing the use of that switch to resume its normal behavior without changing the selected outboard signal chain is easily disabled by the other control elements.

In an example implementation, the MCU can transmit MIDI Program Changes and Continuous Controller messages as a USB payload to a laptop or other general-purpose computer running a DAW (Digital Audio Workstation) or similar VST (Virtual Studio Technology) or AU (Audio Unit) plug-in host. The microcontroller chooses which MIDI program message in response to changes in the rotary encoders and 51993 5-way switch. This arrangement advantageously repurposes the 5-way switch to improve hum reduction and instant voice changes in a significantly reduced form factor, but also adds expressive audio control through motion sensing.

With the solutions herein, the ability of a guitarist to tailor the behavior of his embellished conventional controls based on their favorite software models is a game changer, allowing every user to have a uniquely personalized instrument.

These and other features will be further apparent in view of the following discussion.

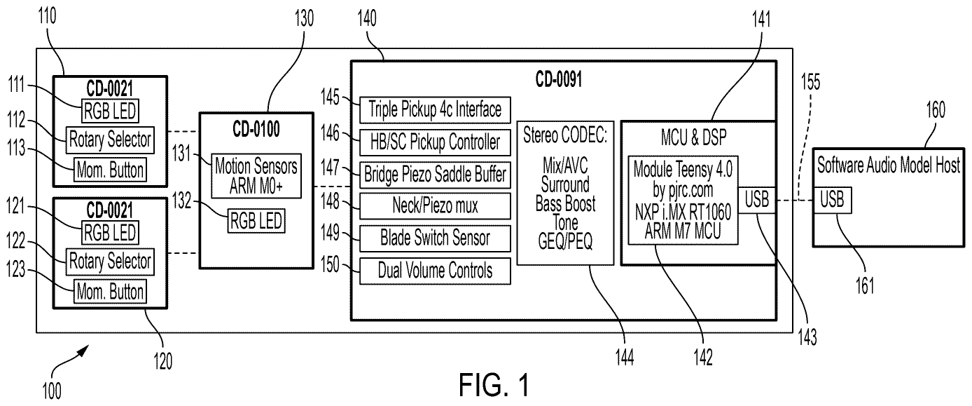

FIG. 1 depicts an example block diagram of an embedded system 100, in accordance with various embodiments. In example implementations, the system 100 includes three or four interconnected printed circuit boards, CD-0021 PCB (one or two instances) 110 and 120, CD-0091 PCB 140, and CD-0100 PCB 130.

CD-0091 is an interface between an attached third-party daughterboard microcontroller (e.g., the Teensy 4.0 USB-based microcontroller development system, PJRC. COM, LLC Sherwood, OR), third-party noiseless pickups with 4-conductor (4c) shielded cables, piezoelectric bridge saddle pickups, the host electric guitar's conventional 51993 5-way switch, two concentric volume controls, and the CD-0100 PCB. It also supports stereo headphones and stereo line level outputs. A wire link between the CD-0091 and an exposed metallic screw allows a programmer to push a virtual program button on the daughterboard microcontroller without removing the pickguard, by shorting it to a grounded exposed metallic part (e.g., bridge, guitar string, etc.)

The CD-0091 includes an MCU/DSP 141 with the Teensy module 142 and a USB connector 143, a stereo CODEC 144, a triple pickup 4c interface 145, a humbucking (HB) or cancelling/single coil (SC) pickup controller 146, a bridge piezo saddle buffer 147, a neck/piezo mux 148, a blade switch sensor 149 and dual volume controls 150.

CD-0100 PCB is the physical link between the microcontroller on CD-0091 PCB and two RGB LED illuminated shaft rotary encoders with integral momentary (mom.) pushbutton switches on up to two CD-0021 PCBs. An option connector allows for control of an external RGB LED for user status control, art illumination or both. Four assembly variants offer the inclusion of up to two motion sensors: an IMU (Inertial Measurement Unit), a ToF (Time of Flight) distance measuring sensor, both, or neither. The IMU option requires an exposed opening in the Faraday shield. The ToF sensor is located midpoint between the two rotary knobs. The ToF sensor option requires an adjacent transparent window in the pickguard. The outputs from either sensor can be scaled and mapped to control any programmable variable.

CD-0021 PCB physically supports an RGB LED rotary encoder and common SMD support circuitry. CD-0100 PCB supports up to two CD-0021s PCBs to critically align the rotary encoder shafts with the constellation of tone control pickguard holes.

In further detail, FIG. 1, shows the relationships between the interconnected PCBs and summarizes the functionality each contributes.

CD-0091 PCB is the MVP (Minimal Viable Product) which links the attached MCU (a) to a stereo CODEC (b), three identical quick-connect 4-conductor (4c), dual-coil pickup inputs (c), the simple novel hum-cancelling (HB) or single coil (SC) pickup configuration controller (d), a bridge piezo saddle buffer circuit (e), an optional second input source selector between the neck pickup or a bridge piezo saddle pickup (f), the 5-way blade switch position sensor (g), and dual pre-CODEC analog volume controls (h). This is an MVP because it comprises a compelling implementation even without the features provided by the CD-0100 PCB and CD-0021 PCB.

Note:
5-way Blade Switch is external and attached to the PCB.
The three 4-con, ductor magnetic pickups are external and attached to the PCB.
The two volume potentiometers are external and attached to the PCB.
The Teensy 4.0 daughterboard module can be external and attached to the CD-0091 PCB, in an example implementation. This module hosts a microcontroller such as the NXP i. MX RT1060 MCU (NXP Semiconductors, Inc., Austin, TX) which is a physical embodiment of an ARM RISC 600 MHz Cortex®-M7 core.

The CD-0100 GPIO General Purpose Input-Output expander (Semtech Corporation, Camarillo, CA, USA) manages the low-frequency static controls of the three RGB LEDs, the ToF on/off logic bit, and a reset input to the IMU. Interrupts generated by the IMU and ToF (if configured) can be monitored by the MCU. The CD-0100 PCB can support one or two CD-0021 PCBs depending on the user interface desired.

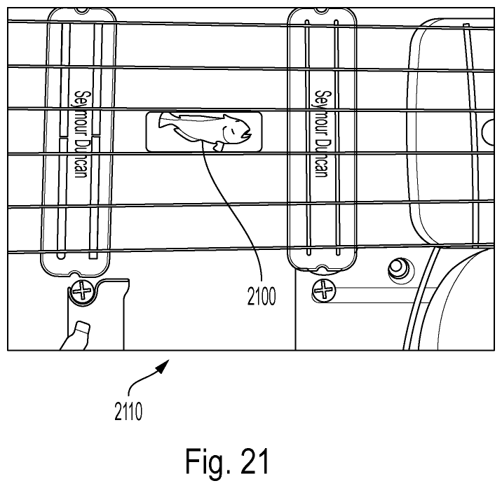

CD-0100 PCB has four design features. First, it establishes the physical locations of the two rotary knobs of the CD-0021 PCBs such that they fit the pickguard holes intended for the supplanted tone potentiometers. Second, it locates the optional ToF real-time hand distance measuring sensor in the ergonomic field between the rotary knobs. This sensor is an example of the motion sensors 131, which are provided using an ARM® Cortex™-M0+ microcontroller (MCU), in an example implementation. Third, it locates the optional Inertial Measurement Unit (IMU) on the smaller option board. Fourth, it adds a connection for an optional RGB LED 132 to be used as an additional status indicator or decorative novel art feature such as the bespoke Flashing Tile Fish lamp embedded between the pickups in an early prototype (see FIG. 21).

CD-0021 PCB contains rotary knobs 112/122, their RGB color function indicators 111/121, momentary contact pushbuttons 113/123, and all of the SMD circuit components required for simplicity of application. CD-0100 supports up to two CD-0021 PCBs.

Regarding the USB port, the Teensy 4.0 module combines the digitized stereo audio from the CODEC on CD-0091 PCB and the MIDI Program Change and Continuous Controller messages over the USB protocol. The attached device (e.g., a laptop) and applications running on the external computer generally require permission to use the sensed USB devices as inputs and outputs subject to their local protocols. Note: MIDI Note On and Note Off as well as the full catalog of MIDI messages are available within the scope of this embodiment.

A software audio model host 160 includes a USB connector 161 which can coupled to the USB connector 143 via a link 155.

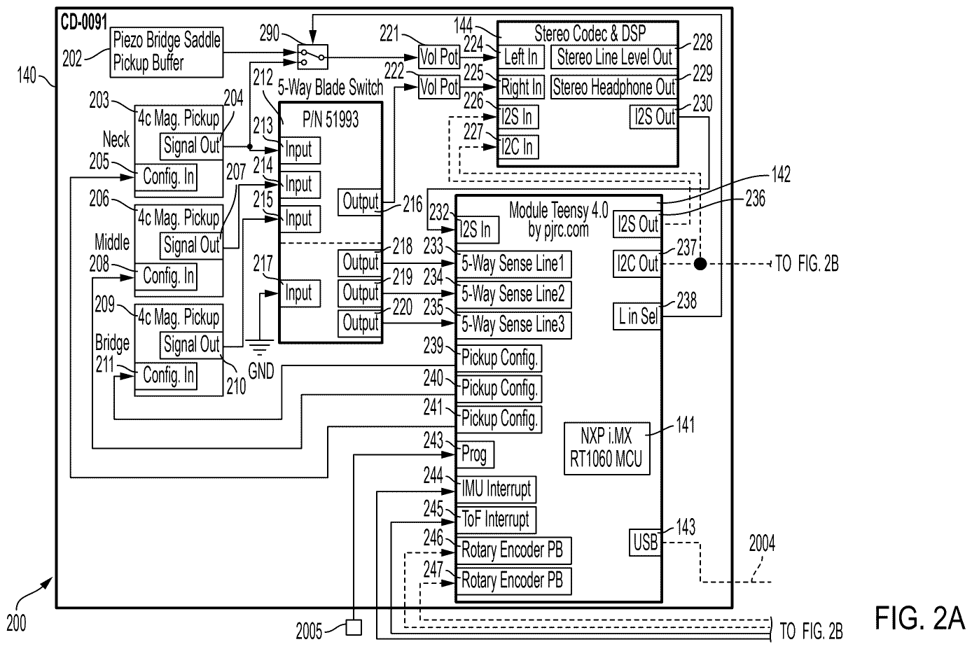

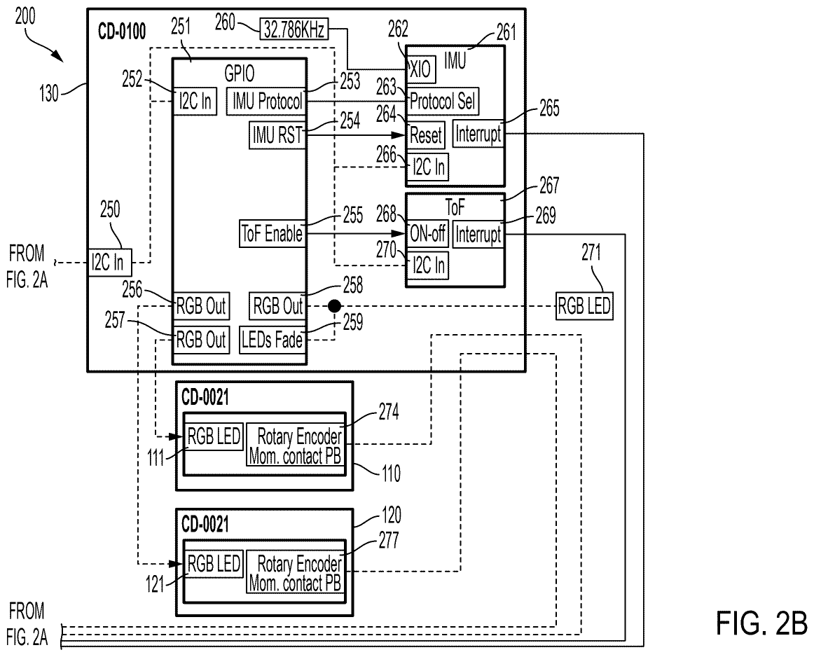

FIGS. 2A and 2B depict first and second parts, respectively, of an example detailed block diagram of a hardware system 200 which is an embodiment of the system 100 of FIG. 1, in accordance with various embodiments. These figures show the connectivity paths linking the main internal and external components of the connected PCBs. The CD-0091 PCB 140, CD-0100 PCB 130 and CD-0021 PCB 110 and 120 of FIG. 1 are depicted.

The neck, middle and bridge magnetic (mag.) pickups 203, 206 and 209, respectively, include configuration inputs 205, 208 and 211, respectively, and signal outputs 204, 207 and 210, respectively. The 5-way blade switch 212 includes inputs 213, 214 and 215 coupled to the signal outputs 204, 207 and 210, respectively. A further input 217 is coupled to ground. The signal output 204 is also coupled to an input of a switch 290. Another input to the switch is from a piezo bridge saddle pickup buffer 202. An output of the switch is coupled to a volume potentiometer 221, and the switch is controlled by a signal from L in Sel 238 of the Teensy module 142. The configuration inputs 205, 208 and 211 are coupled to pickup configuration outputs 241, 240 and 239, respectively, of the Teensy module 142.

The 5-way blade switch 212 includes an output 216 coupled to a volume potentiometer 222 and outputs 218, 219 and 220 coupled to 5-way sense line1 233, line2 234 and line3 235, respectively, of the Teensy module 142.

The stereo codec/DSP 144 has left and right inputs 224 and 225, respectively, coupled to outputs of the volume potentiometers 221 and 222, respectively and I2S and I2C inputs 226 and 227, respectively coupled to I2S and I2C outputs 236 and 237, respectively, of the Teensy module 142. The stereo codec and DSP 144 also has a stereo line level output 228 and a stereo headphone output 229. An I2S output 230 is coupled to the I2S input 232 of the Teensy module 142.

The Teensy module 142 includes a programming input 243 coupled to a contact 2005, an IMU interrupt input 244 coupled to an interrupt output 265 of the CD-0100 PCB 130 (FIG. 2B), a ToF interrupt input 245 is coupled to an interrupt output 269 of the ToF circuit 267, and rotary encoder push button (PB) inputs 246 and 247 (also referred to as momentary contact switches) coupled to rotary encoder momentary contact PB outputs 274 and 277, respectively. The Teensy module 142 also includes the USB port 143 coupled to a path 2004.

In FIG. 2B, the CD-0100 PCB 130 includes a GPIO 251 which has an I2C input 252 coupled to an I2C input 250 which in turn is coupled to the I2C output 237 of FIG. 2A. The I2C inputs 266 and 270 are also coupled to the I2C input 250. RGB outputs 256 and 257 are coupled to the RGB LEDs 121 and 111, respectively. An IMU protocol output 253 is coupled to a protocol selection input 263 of the IMU 261. An IMU reset (RST) output 254 is coupled to a reset input 264. A ToF enable output 255 is coupled to an on-off input 268. An RGB output 258 and an LEDs fade output 259 are coupled to an RGB LED 271.

The IMU 261 includes an XIO input 262 coupled to a clock 260, e.g., at 32.786 kHz.

Regarding a program virtual button, under some circumstances, the Teensy module requires the user to press the Program button located on that PCB, to force it into a state ready to receive a new program upload. That button is inaccessible while installed inside an electric guitar. The workaround is that the same action can be accomplished by shorting a specific Teensy pin to ground (GND). That net is easier to relocate virtually by linking it by wire to a metallic screw holding down the pickguard. Since the CD-0091 PCB is connected to the electric guitar strings with a GND wire, typically at the vibrato bar spring claw or metallic bridge, then any conductive device, e.g., a key, coin, or paperclip can push that virtual button by shorting that screw to the grounded exposed metal.

The signal sources are the piezo and magnetic pickups connections on the left side of the CD-0091 PCB.

The three magnetic pickups 203, 206 and 209 are presented to the 5-way blade switch 212 (at inputs 213, 214 and 215, respectively), which connects them as in a conventional implementation. The selected pickup combination is presented to a volume control in the same way as a conventional wiring, though far simpler as the intrinsic complexity is managed by the CD-0091 PCB. The volume control output returns to CD-0091 PCB in the same 3-conductor cable separated by a ground wire to minimize crosstalk and is digitized by the right channel of the stereo CODEC 144.

An optional high impedance piezo buffer 202 presets its output to the 2-to-1 SMD analog switch 290 which allows the left channel of the CODEC to choose between the piezo or the neck pickup. This feature offers electric guitars with 3 pickups and conventional 5-way switches a new voice combination in common with 2-pickup 3-way switch architecture guitars: the combination of neck and bridge pickups but also enables a wider piezo spectrum to combine with one or two conventionally selected magnetic pickups. If the 2-to-1 SMD switch is installed, it can be controlled by software on demand.

The CD-0091 PCB has options to omit the 2-to-1 SMD switch and hard-wire either one of the input options. In either case, the left channel signal is presented to the second volume control connector or bypassed by shorting the send and receive pins of that pot connector.

Concentric volume potentiometers (pots) 221 and 222 are available to control the input levels to both channels of the CODEC, but alternative controls of these inputs are available as software options in the CODEC or DSP portion of the MCU using the rotary encoders linked in firmware to internal variables.

The timing and communication link between the MCU and CODEC is the I2S (Inter-IC Sound) PCM pulse-code modulation serial interface.

In this specific embodiment, the line and headphone outputs 228 and 229, respectively, are not necessary but are available.

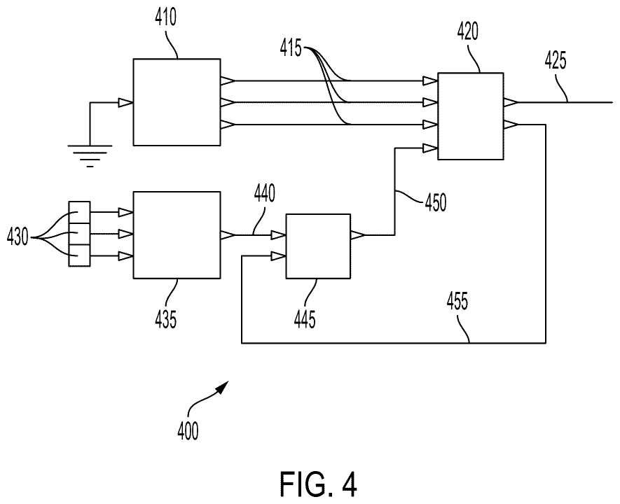

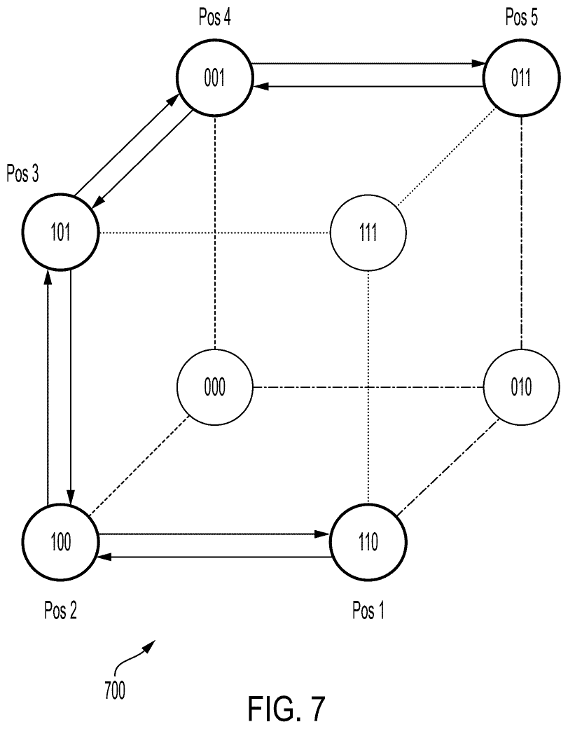

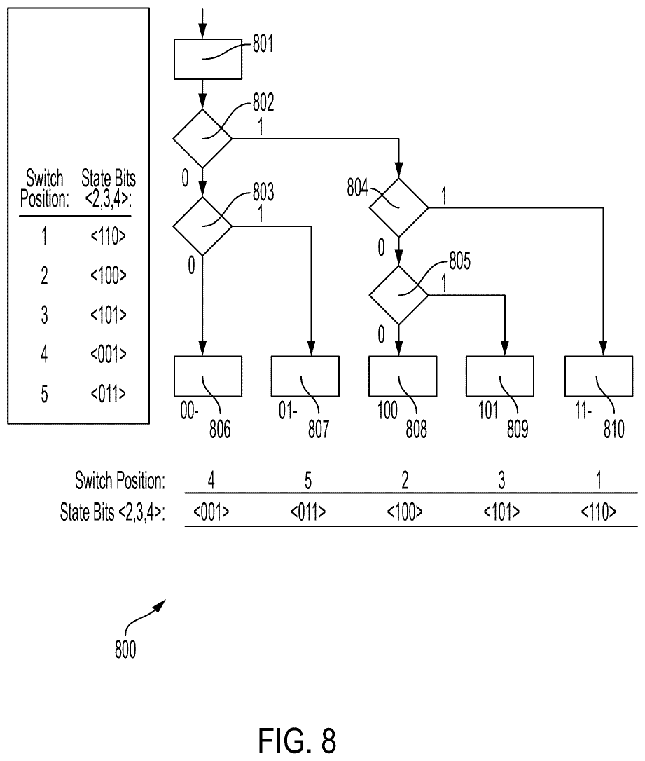

The novel repurposing of the tone-side of the conventional 5-way switch is shown but will be explained later in the discussion of FIG. 4. The operation of the 5-way sense lines will be explained in connection with FIGS. 7 and 8.

The MCU can configure all three 4-conductor pickups as either single-coil or hum-cancelling independently of each other and any other digital tone selection. This feature is not enforced but offers a novel solution to the common hum issue.

The I2C (Inter-Integrated Circuit) serial communication protocol is a bidirectional 2-wire link from the MCU to the CODEC, the IMU, ToF, and GPIO Expander on the CD-0100 PCB as each of these devices requires a master controller.

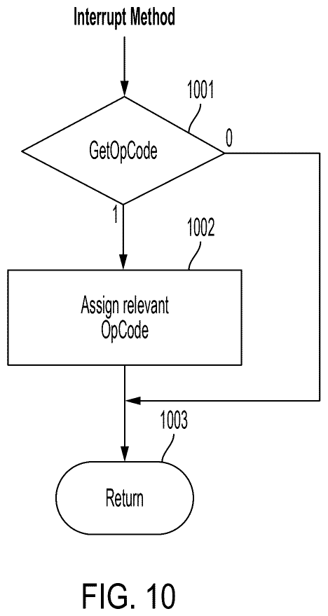

The rotary knobs and pushbutton controls on the CD-0021 PCBs are monitored by interrupt sensitive inputs on the MCU. The methods implemented by the interrupt service routines are shown in FIGS. 10-12B and will be explained in those sections. FIG. 10 is a generalized template for ISRs which must be kept as minimal as possible to prevent interrupt generating control inputs from disturbing other actions in process in the MCU.

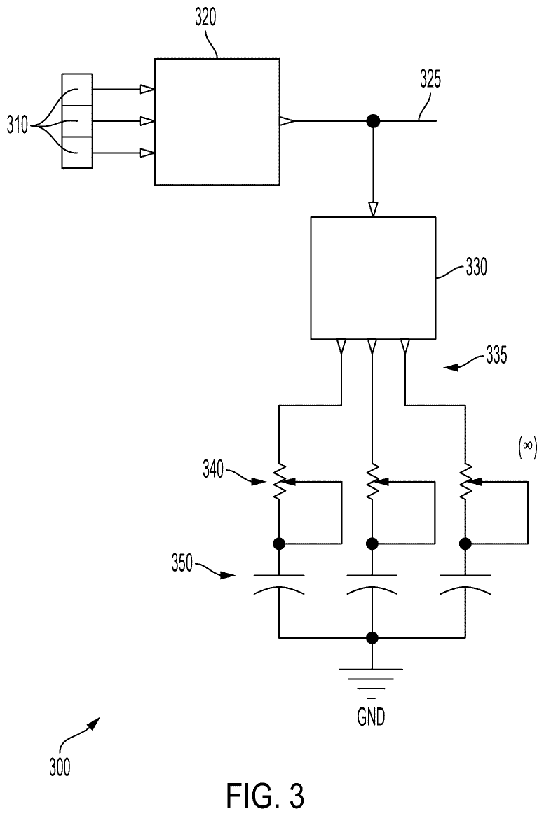

FIG. 3 depicts a circuit 300 depicting an example comparative use of 5-way switch and tone selector, in accordance with various embodiments.

Three independent magnetic pickups 310 are strategically located below different regions of the vibrating string.

The 51993 5-way pickup selector blade switches 320 and 330 are depicted.

The composite output 325 of the selected pickups and selected RC tone filters is depicted.

Three nodes 335 correspond to the three pickup inputs. Although it is possible to have three RC filters, historically only 2 tone controls are wired, leaving one position of the 5-way switch as full-bandwidth. They are topographically identical, however differentiated by component values.

RC circuits include resistors 340 and capacitors 350 coupled to the Three nodes 335. The value of one resistor is infinity, so it and its connected capacitor (C) are not physical components.

In other words, it is a generalized circuit diagram of comparative electric guitar tone controls showing how: One half of the 2P5T (51993) 5-way switch selects one or two adjacent magnetic pickups, and the other half of the 2P5T (51993) 5-way switch selects one or two independent RC tone controls.

Three RC circuits are shown to illustrate that, although one of the three typically has an infinite series resistance, that isn't necessary. In either case, it represents a unique tone option.

There have been different physical implementations of the conventional 5-way pickup selection switch, but for this analysis, a specific model is referenced: the model 51993.

There are two poles and three net connection options for each pole. One pole is used to choose a specific pickup or a combination of two adjacent pickups. The other pole is used to add an RC high-frequency roll off filter to the selected pickup set. Different values of R and C affect the tone of the selected pickup set. The values of C is fixed and different from one another. The value of R is determined by the rotation of a potentiometer operating as a linear tone control.

In the first position, the bridge pickup alone is selected. In the third position, the middle pickup alone is selected. In the fifth position, the neck pickup alone is selected.

In the second position, the outputs of the bridge and middle pickups are shorted together. In the fourth position, the middle and neck pickups are shorted together. Because the middle pickup is wired with a complementary polarity, the noise picked up by one is negated by the equal and opposite noise picked up by the other in both the second and fourth positions.

Because the coils of the pickups are under different regions of the vibrating strings, the harmonics they sense are very different when combined, giving the second and fourth positions very recognizable and pleasing classic voices.

FIG. 4 depicts an example circuit 400 which provides a novel use of a 5-way switch and includes a digital position sensor, in accordance with various embodiments. The circuit provides a digital position sensor.

Three independent magnetic pickups 430 are located below different regions of the vibrating string.

The 51993 5-way pickup selector blade switches 410 and 435 are depicted.

A composite output 440 of the selected pickups is depicted.

A stereo CODEC 445 is depicted, though only the right stereo channel is shown for simplification.

An I2S digital audio output 450 is provided to the microcontroller 420.

In paths 415, the tone half of the 51993 5-way blade switch is repurposed as a position sensor. Instead of a 3-input 1-output switch, it is reversed, as 1-input 3-output switch. The single input is wired to ground, and the three outputs are pulled high with internal pullup resistors in the microcontroller (MCU) input pins. The inputs have interrupt functionality and cause an interrupt whenever any input changes from a logic one to a zero or from a logic zero to a one. Further details are provided in connection with FIG. 8.

The microcontroller 420 has an I2S digital audio input and timing control outputs (the digital output is omitted in this process). The MCU also has special digital inputs in which internal pullup resistors can be attached and flexible interrupt behaviors assigned.

A path 425 provides a digitized audio payload over USB-to-host computer equipment.

A path 455 provides the I2S timing controls (bit clock, word clock, and channel flag) from the MCU to the CODEC.

Simply put, FIG. 4 is a generalized circuit diagram of novel electric guitar tone controls.

Half of the 2P5T (51993) 5-way switch (2) selects one or two adjacent magnetic pickups 1.

The selected magnetic pickup signal is converted into the digital domain by a CODEC 4 controlled by and processed within a microcontroller 420.

Half of the 2P5T (51993) 5-way switch is repurposed as a switch position detector using the paths 415. The common node is connected to logic ground. Each of the three output nodes are connected to special inputs to the microcontroller. The special features of the microcontroller inputs are: they have optional pull-up resistors, which when enabled result in a default logic state of 1; the switch shorts one or two sense lines to GND and each transition triggers an MCU interrupt; and the MCU inputs can be configured to function as hardware interrupts, triggered by either logic state or transition.

Special features within the CODEC may adjust the tone under control of the microcontroller prior to USB packetization.

Characteristics of the microcontroller 420 include: the microcontroller library can generate MIDI messages; digital signal processing elements in the microcontroller library can adjust the tone prior to USB packetization; and the stereo CODEC inputs can be combined with MIDI messages and formatted into a USB payload on the path 425 to external computing equipment.

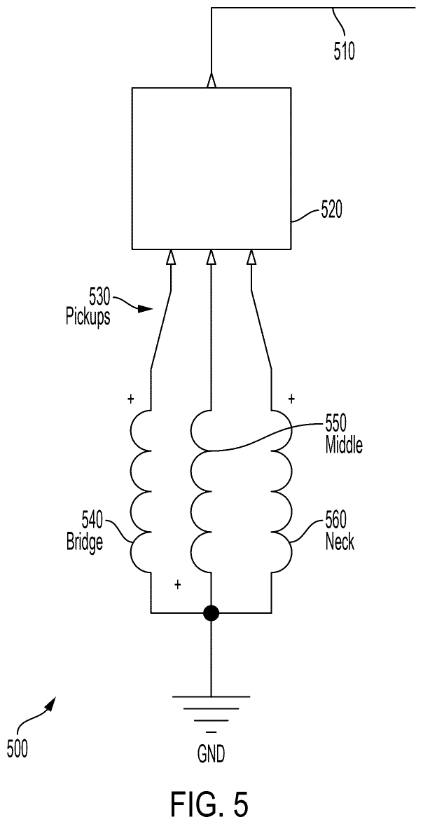

FIG. 5 depicts an example circuit 500 which provides a comparative use of a 5-way switch and includes a pickups selector, in accordance with various embodiments.

A set of pickups 530 includes a bridge pickup 540, a middle pickup 550 and a neck pickup 560. The bridge and neck pickup polarities can be referred to as North (“+”) side (N) hot. The middle pickup polarity can be referred to as South (“−”) side(S) hot. This arrangement has the benefit of functioning as a hum-cancelling set of coils in positions 2 and 4 of the 5-way switch when the middle pickup is wired in parallel with either the bridge or neck pickup. This benefit is not present in positions 1, 3, and 5 as there is only a single coil contaminated with ambient electromagnetic hum. In the “half-way” positions of 2 and 4, the middle pickup is shorted to its adjacent pickup. Because the polarities are complementary, common hum is cancelled.

The 51993 5-way pickup selector blade switch 520 is depicted.

A path 510 provides the composite output of the selected pickups and selected RC tone filters.

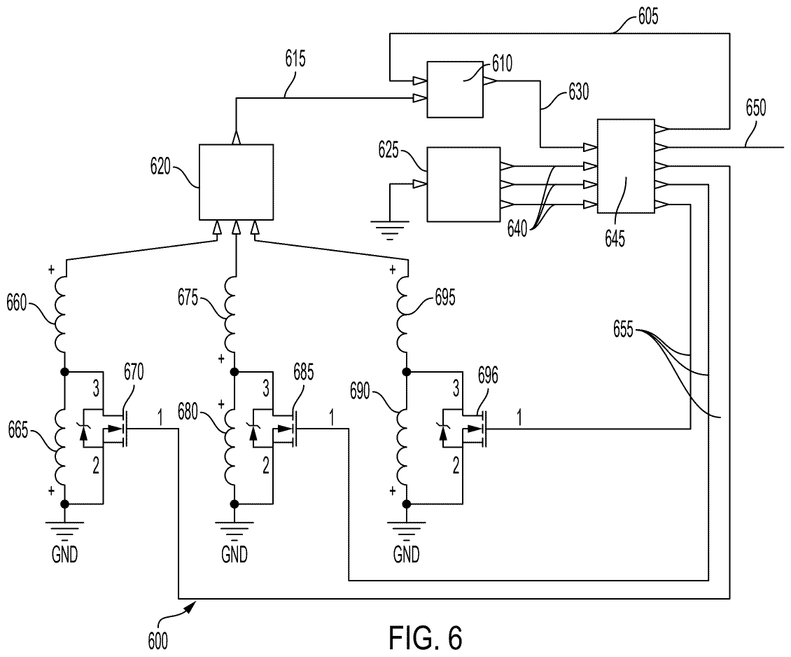

FIG. 6 depicts an example circuit 600 which provides a novel method to improve pickup noise rejection, in accordance with various embodiments.

The bridge pickup includes North (+) and South (−) sides 660 and 665, respectively. The middle pickup includes South (−) and North (+) sides 675 and 680, respectively. The neck pickup includes North (+) and South (−) sides 695 and 690, respectively. There are three dual coil (4-conductor) pickups, where each coil is attached to its pair in complementary polarity. This is also true for the middle pickup which has a different complementary wiring. See the discussion of the three transistors below.

The 51993 5-way pickup selector blade switches 620 and 625 are depicted.

A path 615 provides the composite output of the selected pickups.

A stereo CODEC 610 is depicted, though only one channel is shown for simplification.

The I2S digital audio output 630 to the microcontroller 645 is depicted.

In paths 640, the tone half of the 51993 5-way blade switch is repurposed as a position sensor. See FIGS. 4-6 above.

The microcontroller 645 has an I2S digital audio input, USB output, three sense lines from the novel 5-way position sensor, and several digital outputs.

Path 650 provides a digitized audio and a MIDI command payload over USB-to-host computer equipment for additional status indication.

Path 605 provides the I2S timing controls (bit clock, word clock, and channel flag) from the MCU to the CODEC, as in FIGS. 4-9.

Paths 655 provide three program asserted digital logic outputs to independently configure each of the three magnetic pickups as either single-coil or hum-cancelling dual coil.

Three transistors 670, 685 and 696 short the link between the pickup dual coils to ground, effectively reducing each one separately to a single-coil configuration. This allows this arrangement to solve the original problem of reducing noise in positions 2 and 4, but also to solve the remaining problem of reducing the noise in positions 1, 3, and 5, while retaining the classic voices of positions 2 and 4. These would otherwise be mutually exclusive solutions. A simple illustration for the positions 1 through 5 would be: BMN (Bridge, Middle, Neck pickups): H−−, Ss−, −H−, −sS, −−H where H is hum-cancelling, S is a North oriented single coil, s is a South oriented single-coil, and “−” is not normally connected. The neck pickup configuration can matter when the 2-to-1 SMD switch (FIGS. 2-5c) selects the neck pickup over the optional piezo bridge saddle pickup. In that case, it can and should be “H” for all positions except position 4 for optimal benefit, though that is left to the discretion of each programmer.

Other possible desirable pickup configurations might be (where “S” is a North-oriented single coil pickup, and “s” is a South-oriented single coil pickup: S−−, Ss−, −s−, −sS, −−S for a Vintage sound; and H−−, HH−, −H−, −HH, −−H to replicate the performance of a Modern “Noiseless” pickup set, where “H” is a dual-coil hum-cancelling pickup. These could be selected using one of the rotary controls, offering the artist more voice choices including: “Vintage” (noisy); “Modern” (noiseless/soulless); and “Hybrid” (this improved embodiment) Other configurations are possible to replicate the voices of pickups installed in many existing guitars, warts and all, e.g., HsS, HsH, etc.

FIG. 7 depicts an example classic representation 700 of 5-way switch as a sequential Finite State Machine (FSM), in accordance with various embodiments. FSMs are digital devices that have stable states defined by exclusive combinations of bits. The FSM can transition between states limited to those the direction arrows allow. This embodiment of the repurposed 5-way switch looks like a classic state machine in this regard, with each state represented by a switch position and the unique bit combinations associated with each state presented to the microcontroller for monitoring. Each circle represents a state of the FSM, where the corresponding three-bit code depicts 5-way switch position sense bits. The switch has five positions: Pos 1, Pos 2, Pos 3, Pos 4 and Pos 5, represented by sense bits 110, 100, 101, 001 and 011, respectively.

FIG. 8 depicts a flowchart 800 of an example generalized method of determining a switch position from the state of Sequential Finite State Machine (SFSM) bit values, in accordance with various embodiments. The physical challenge of evaluating the 5-way switch results from the speed that it is capable of transitioning from one extreme to the other. The three bits that identify the rest states of the switch are like Gray code, also known as a unit distance code. That is, there is a single bit difference between the bits representing each adjacent state. The bits may be zero (0) or one (1). Each state transition involves changing a one to a zero or a zero to a one. Either transition triggers an ISR which assigns an opcode with a common resolution method. Changing the blade switch between positions 1 and 5 activates 4 instances of an identical ISR. The first one disallows all others until it has been handled. A short delay before reenabling interrupts ensures reliable operation.

A MIDI operational code (opcode), or MIDI message, is a digital instruction used to control or communicate between MIDI-compatible devices. These messages are sent via the MIDI protocol and can dictate actions like playing a note, changing a sound, or controlling other parameters on a musical instrument or software.

This general algorithm evaluates all three state bits in a branching topology resulting in the identification of the switch position resting in only one of the 5 possible states after only a few rapid sequential tests. The bit values being evaluated for switch positions 1 through 5 are: <110>, <100>, <101>, <001>, and <011>. These are fixed by the physical implementation of the method. Each bit is pulled high by an internal MCU pullup resistor until the GND pole shorts the selected node(s). It can only short one or two adjacent nodes to GND (0) at a time, beginning with <110>and ending with <011>. In the diagram and following explanation, the bit labels are arbitrarily assigned <2,3,4>.

Step 801 implements a slight delay of about 250 ms to avoid triggering multiple unintended MIDI Program change messages between extreme switch positions. Without this, retriggering is possible because the processor is very fast. Because there is one bit difference between each state, and bit transitions always trigger an interrupt, it is important to hold off evaluating the state until it is reliably stable.

In decision step 802, in one embodiment, the algorithm examines bit 2 (the first state bit), If it is a logic 1, it branches right to decision step 804. If not, it falls to the test below at decision step 803.

In decision step 803, in this embodiment, the algorithm examines bit 3 (the second state bit). In both decision steps 802 and 803, if the read bit value is a logic 1, the flow branches to the right. If not, the flow proceeds to the test below. If the decision step 803 detects a 0, the identified switch position is 4 (step 806). If the decision step 803 detects a 1, the identified switch position is 5 (step 807).

Decision step 804 examines bit 3 (the second state bit) when the first state bit=1. If it is a 0, the decision step 805 is reached. If it is a 1, the identified switch position is 1 (step 810).

In decision step 805, in this embodiment, the algorithm examines bit 4 (the third state bit). If the read bit value is a logic 1, the identified switch position is 3 (step 809). If it is a 0, the identified switch position is 2 (step 808).

In summary, the identified switch positions are from left to right: 4, 5, 2, 3, and 1. Other solutions exist within the framework of this algorithm if the order of bits or order of evaluation of the bits is transposed, or if the switch position numbers are redefined.

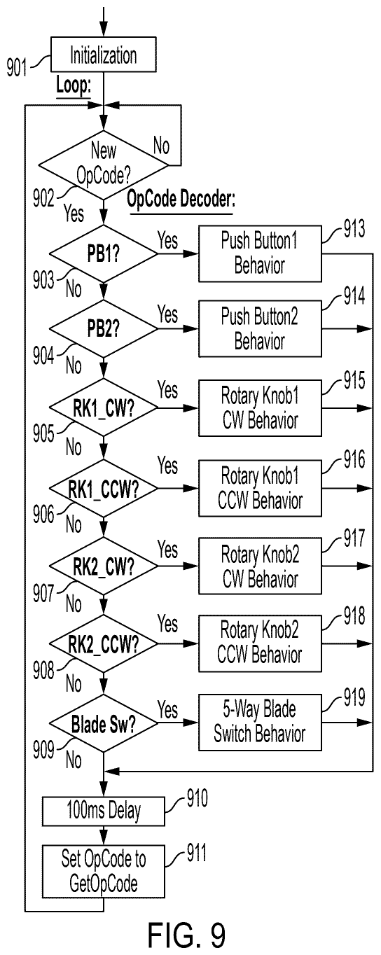

FIG. 9 depicts a flowchart of an example system control method, simplified, in accordance with various embodiments.

Step 901 is an initialization. The control method waits for an Interrupt Service Routine to define a pending action. The actions are called opcodes. A decision step 902 determines if there is a new OpCode. There are seven opcodes covering the movement of the manually articulated controls: two pushbutton press opcodes (PB1 and PB2 at decision steps 903 and 904, respectively), four rotary encoder opcodes sensing clockwise (RK1_CW and RK2_CW at decision steps 905 and 907, respectively) and counterclockwise (RK1_CCW and RK2_CCW at decision steps 906 and 908, respectively) motions for two rotary encoders (Rotary Knob1 and Rotary Knob2), and one opcode (Blade Sw at decision step 909) triggered by any motion of the 5-way switch. A default opcode is reserved for none of the above, or idle until something happens.

Step 910 implements a 100 ms delay and step 911 sets OpCode to GetOpCode.

The omission of any pushbutton release opcodes does not imply that that they aren't allowed or aren't part of this method. They aren't needed in this basic control example but can be added as needed.

The main control is modeled as one of two loops: 1. wait, and 2. direct the behavior to a method resolving the intended action within its context.

This method involves checking the value of the opcode with known expected values. The first one evaluated is one that results in no action. That keeps the main loop alert for the registration of opcodes that call for some action.

The first two opcodes respond to button presses. Each button press triggers a specific behavior (blocks 913 and 914).

The next two opcodes are triggered by clockwise or counterclockwise rotations of Rotary Knob #1 and have unique defined behaviors or methods (blocks 915 and 916).

These are followed by opcodes for clockwise or counterclockwise rotations of the rotary knob #2 which have unique defined behaviors or methods (blocks 917 and 918). In this embodiment, the behaviors are very different. In other embodiments, the behaviors can be similar. Future embodiments are reserved for additional embellishments of the features.

The final opcode evaluation is associated with the position of the 5-way blade switch (block 919) which arguably is the most useful item in the guitarist's hand control toolbox as it can result in very sudden, accurate, and significantly contrasting voice changes requiring a lower level of finesse and visual feedback. This possibly dichotomous feature is uniquely descriptive of the solutions herein as the conventional use of the 5-way switch nearly always results in more nuanced voice changes than are possible with the solution's arbitrary MIDI Program Changes.

FIG. 10 depicts a flowchart of an example generalized method of handling interrupts, in accordance with various embodiments. The interrupt Service Routines (ISR) are intentionally designed to accomplish the minimal amount of work, passing the main complex tasks to branches or subroutines called from the main loop. That is because interrupts, though necessary, are intrinsically rude. The minimal task in these cases is that they assign a unique opcode flag to a variable that is available in both time domains.

All the Interrupt Service Routines can follow a similar method: they assign an opcode associated with the interrupt source if it is not disallowed by a special flag.

In the flowchart, a decision step 1001 determines whether a new OpCode is allowed/created by the GetOpCode flag. If the result is true (1), step 1002 assigns the relevant OpCode and step 1003 returns to the start of the method. If the result is false (0), step 1002 is bypassed.

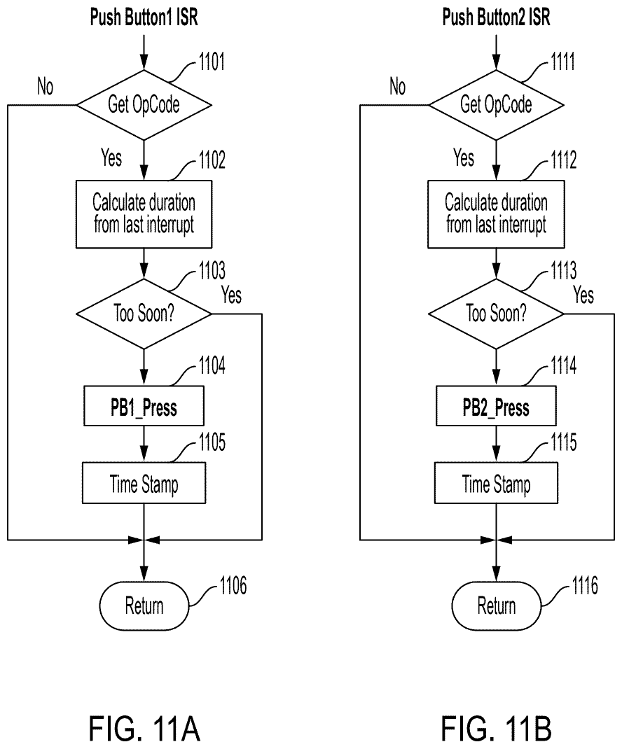

FIG. 11A depicts a flowchart of an example method of handling pushbutton-initiated interrupts, for a first pushbutton Interrupt Service Routine (ISR), in accordance with various embodiments.

At the end of any behavior managed in the main loop (FIG. 9), the gating Boolean is set to a “GetOpCode” flag that will hold the main loop in a wait state until a new action is pending. This Boolean (FIG. 10) requires each ISR to log a new event.

The first test in the ISR reacting to a first button press is to check the value of the GetOpCode flag (decision step 1101). If it indicates a previous event is still being managed, the interrupt is ignored.

The ISR then determines if sufficient time has elapsed since the previous interrupt (steps 1102 and 1103). If not, the interrupt is ignored slowing the rate at which interrupts may be recognized.

Only then is the new opcode PB1_Press defined to allow the main loop to evaluate the interrupt source and its intended behavior (step 1104).

Before the ISR exits, it captures the time stamp to be used to filter redundant interrupts (step 1105). The processes returns to the start at step 1106.

FIG. 11B depicts a flowchart of an example method of handling pushbutton initiated interrupts, for a second pushbutton Interrupt Service Routine (ISR), in accordance with various embodiments. This method is similar to FIG. 11A but is for a second pushbutton ISR.

In the flowchart, a decision step 1001 determines whether a new OpCode is received. If the result is true (1), step 1002 assigns the relevant OpCode and step 1003 returns to the start of the method. If the result is false (0), step 1002 is bypassed.

The first test in the ISR reacting to a first button press is to check the value of the GetOpCode flag (decision step 1111). If it indicates a previous event is still being managed, the interrupt is ignored.

The ISR then determines if sufficient time has elapsed since the previous interrupt (steps 1112 and 1113). If not, the interrupt is ignored slowing the rate at which interrupts may be recognized.

The new opcode PB2 Press is defined to allow the main loop to evaluate the interrupt source and its intended behavior (step 1114).

A time stamp is captured as discussed at step 1115. The processes returns to the start at step 1116.

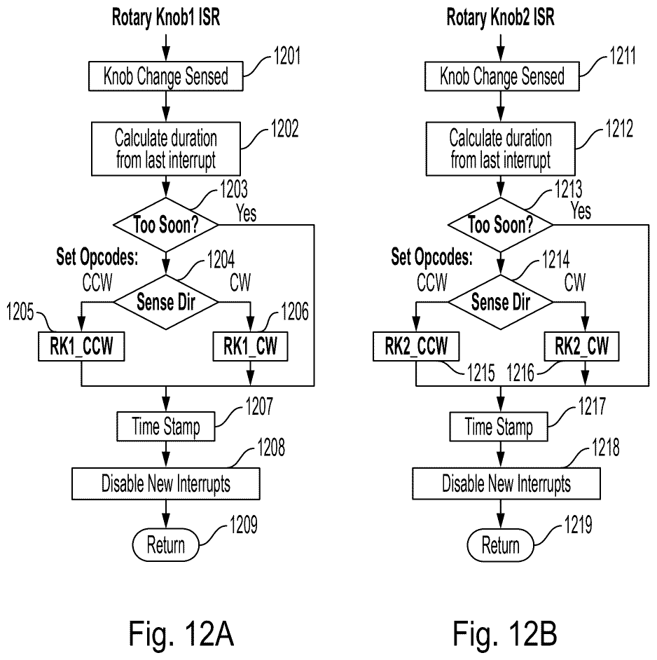

FIG. 12A depicts a flowchart of an example method of handling rotary knob-initiated interrupts, for a first rotary knob ISR, in accordance with various embodiments.

This ISR is similar to that of the button press in that it also filters out inordinately repetitive interrupts, responding only to the first one in a rapid series. A simple test establishes the direction of rotation.

Each rotary encoder issues opcodes identifying itself as the source as well as the direction of rotation, allowing the main loop to define different behaviors for each.

Before the ISRs exit, they capture the time stamp to be used to filter redundant interrupts.

Step 1201 includes sensing a knob position change. Step 1202 calculates the duration from the last interrupts and decision step 1203 determines whether it is too soon. If it is too soon, step 1207 obtains a time stamp, step 1208 disables new interrupts and step 1209 returns to the start of the process. If it is not too soon, a decision step 1204 senses the rotation direction of the knob. If the rotation is CCW, the OpCode RK1_CCW is set at step 1205. If the rotation is CW, the OpCode RK1_CW is set at step 1206.

FIG. 12B depicts a flowchart of an example method of handling rotary knob-initiated interrupts, for a second rotary knob ISR, in accordance with various embodiments. This method is similar to FIG. 11A but is for a second rotary knob ISR.

Step 1211 includes sensing a knob position change. Step 1212 calculates the duration from the last interrupts and decision step 1213 determines whether it is too soon. If it is too soon, step 1217 obtains a time stamp, step 1218 disables new interrupts and step 1219 returns to the start of the process. If it is not too soon, a decision step 1214 senses the rotation direction of the knob. If the rotation is CCW, the OpCode RK2_CCW is set at step 1215. If the rotation is CW, the OpCode RK2_CW is set at step 1216.

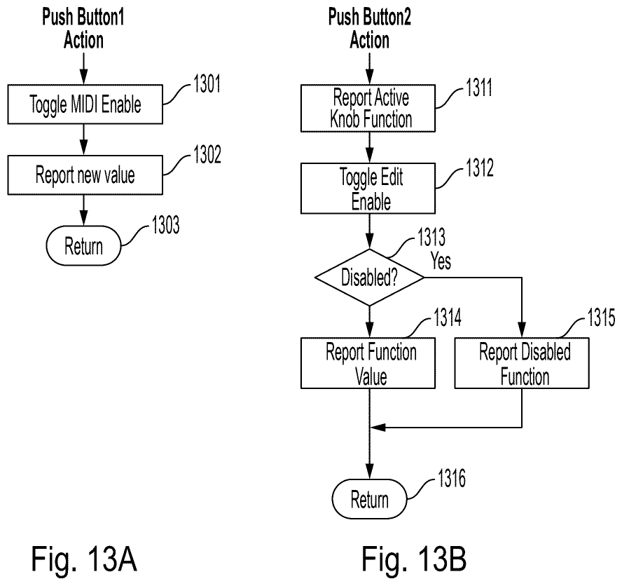

FIG. 13A depicts a flowchart of an example method depicting a novel behavior of pushbuttons, for a first pushbutton action, in accordance with various embodiments. When there is a Push Button1 action, step 1301 includes Toggle MIDI Enable, step 1302 includes Report new value, and step 1303 is a Return.

In the initial embodiment, the 5-way switch adds the switch position number (0, 1, 2, 3, or 4) to the bank pointed to by Rotary Encoder #1, indicated by the colors Yellow (0), Green (5), Cyan (10), Blue (15), Magenta (20, and Red (25). Changes in the 5-way switch and Rotary Encoder #1 will send the resulting MIDI Program change (0 to 29) to the VST/AU Plugin over the USB bus where, presumably, they are organized in a reasonable manner, e.g., the 5-way switch position will address kinds of effects and the rotary encoder with address variants of those kinds.

The caveat of this method is that sometimes a guitarist will want to change the pickup selection without changing the plug in (guitar effect). Pressing pushbutton 1 toggles the MIDI Enable control bit such that no MIDI Program Change message is sent as the pickup selection changes. Pressing it again reenables MIDI broadcasting.

FIG. 13B depicts a flowchart of an example method depicting a novel behavior of pushbuttons, for a second pushbutton action, in accordance with various embodiments. When there is a Push Button2 Action, step 1311 includes Report Active Knob Function, step 1312 includes Toggle Edit Enable and step 1313 determines whether the process is disabled. If the answer to the Disable decision block is yes, Report Disabled Function is reached at step 1315 followed by a Return at step 1316. If the answer to the Disable decision block is no, Report Function Value is reached at step 1314 followed by the Return.

In this embodiment, the second rotary encoder addresses a programmable variable. Pressing its pushbutton toggles the Edit Enable bit, allowing further rotations to adjust the value of the variable and to send MIDI Continuous Controller messages to the VST/AU plugin over the USB cable, and/or adjusting an internal variable or variables in one of the embedded DSPs (One in the CODEC, the other in the MCU).

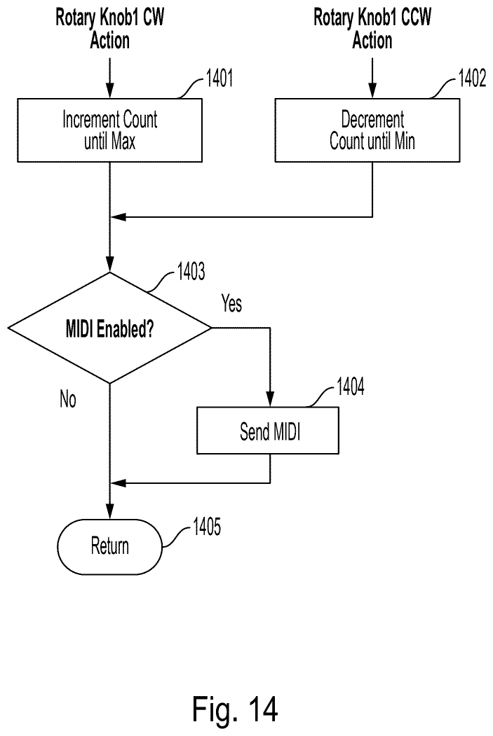

FIG. 14 depicts a flowchart of an example method depicting a novel rotary knob behavior, for a rotary knob clockwise (CW) action and a rotary knob counterclockwise (CCW) action, in accordance with various embodiments. When there is a Rotary Knobl CW action, step 1401 includes Increment Count until Max followed by a decision step 1403 which determines whether MIDI is enabled. If the answer is yes, Send MIDI is reached at step 1404 followed by a Return at step 1405. If the answer is no, the Return is reached. When there is a Rotary Knob 1 CCW action, step 1402 includes Decrement Count until Min followed by the decision step 1403.

In this embodiment, each position of the rotary encoder evaluates whether MIDI is enabled. If so, a new MIDI Program Change message is calculated and sent over USB to a host computer running VST or AU software model plugins.

Another embodiment might select the MIDI argument but refrain from sending the MIDI Program Change message until the shaft button is asserted. In this method, presets could be selected without audibly cycling through possibly different voice variants.

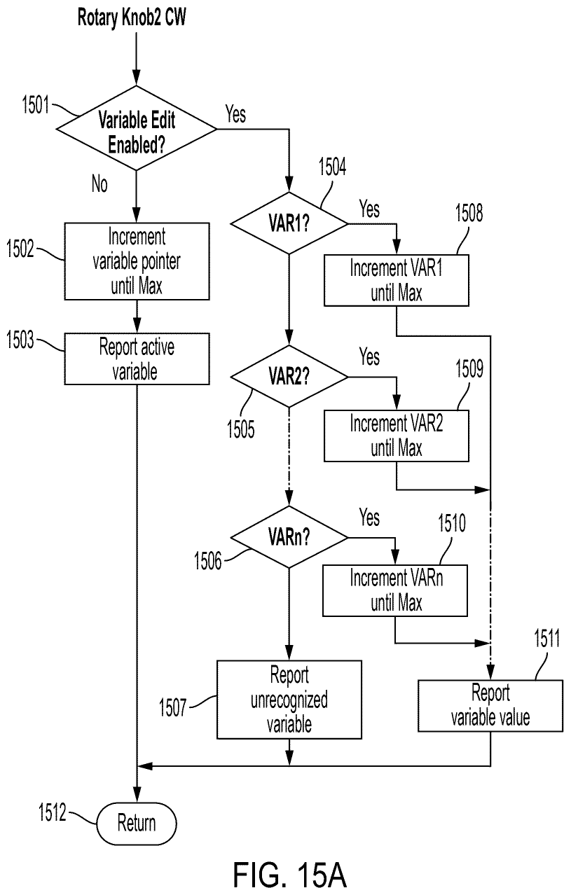

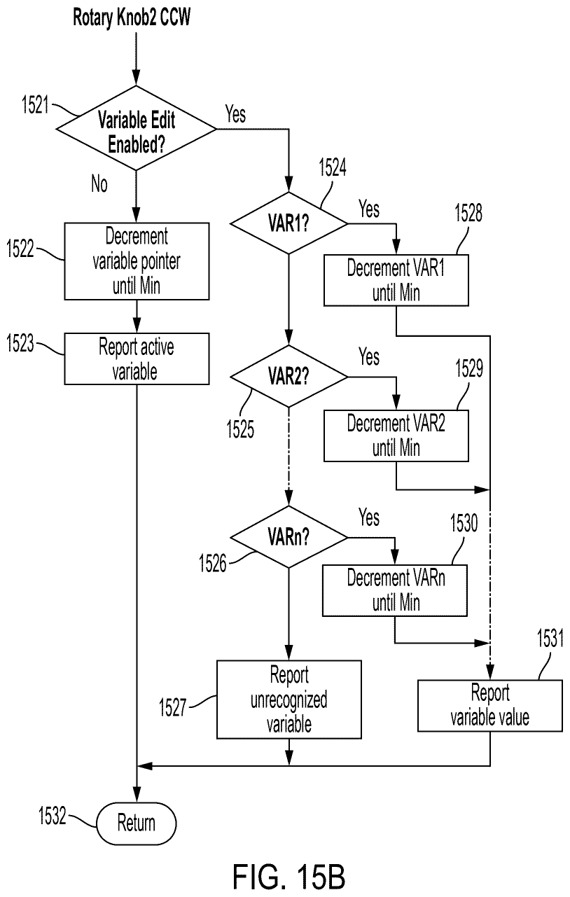

FIG. 15A depicts a flowchart of an example method depicting another novel Rotary Knob Behavior, for a rotary knob clockwise (CW) action, in accordance with various embodiments. When there is a Rotary Knob2 CW action, a decision step 1501 determines whether Variable Edit is Enabled. If the answer is no, steps are reached for Increment variable pointer until Max (step 1502), Report active variable (step 1503) and Return (step 1512). If the answer is yes, a decision step 1504 determines whether VAR1 is set. If the answer to VAR1? is yes, steps are reached for Increment VAR1 until Max (step 1508), Report variable value (step 1511) and Return. If the answer to VAR1? is no, a decision step 1505 is reached for VAR2? If the answer to VAR2? is yes, steps are reached for Increment VAR2 until Max (step 1509), Report variable value and Return.

If the answer to VAR2? is no, a decision step 1506 is reached for VARn? (where n is the index of a list of n VARs, e.g., VAR4, VAR5, VAR6). If the answer to VARn? is yes, steps are reached for Increment VARn until Max (step 1510), Report variable value and Return. If the answer to VARn? is no, steps are reached for Report unrecognized variable (step 1507) and Return.

Note that FIG. 15A provides a general paradigm. The variables can be scalar like volume knobs, or Boolean enables, like motion sensing, or remote VST effects on-off switches.

FIG. 15B depicts a flowchart of an example method depicting another novel Rotary Knob Behavior, for a rotary knob counterclockwise (CCW) action, in accordance with various embodiments. The method is similar to that of FIG. 15A except that VAR1, VAR2, . . . , VARn are decremented until Min is reached instead of incremented until Max is reached.

In particular, when there is a Rotary Knob2 CCW action, a decision step 1521 determines whether Variable Edit is Enabled. If the answer is no, steps are reached for Decrement variable pointer until Min (step 1522), Report active variable (step 1523) and Return (step 1532). If the answer is yes, a decision step 1524 determines whether VAR1 is set. If the answer to VAR1? is yes, steps are reached for Decrement VAR1 until Min (step 1528), Report variable value (step 1531) and Return. If the answer to VAR1? is no, a decision step 1525 is reached for VAR2? If the answer to VAR2? is yes, steps are reached for Decrement VAR2 until Min (step 1529), Report variable value and Return.

If the answer to VAR2? is no, a decision step 1526 is reached for VARn?. If the answer to VARn? is yes, steps are reached for Decrement VARn until Min (step 1530), Report variable value and Return. If the answer to VARn? is no, steps are reached for Report unrecognized variable (step 1527) and Return.

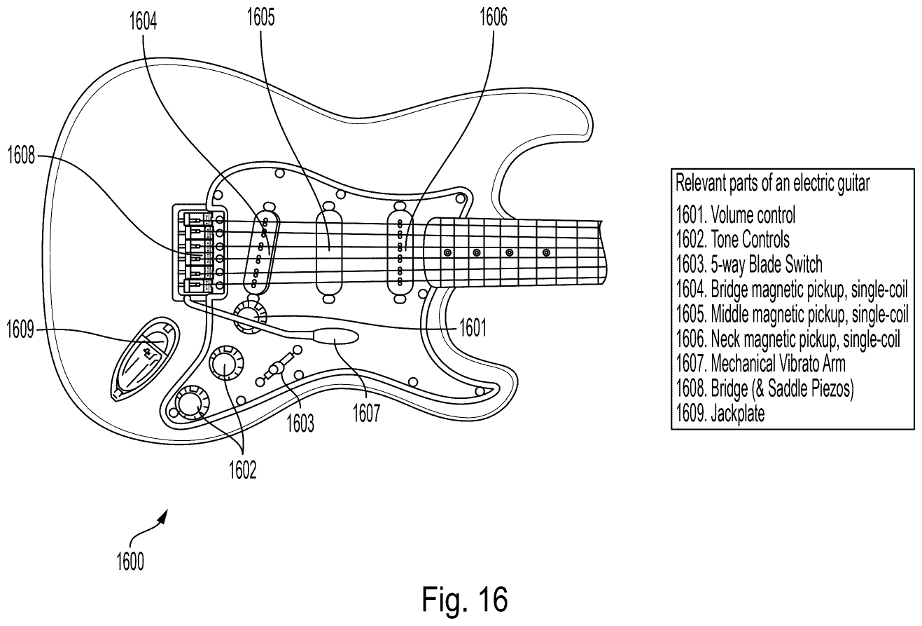

FIG. 16 depicts an example view of a parts map for a guitar 1600, in accordance with various embodiments. The example is based on the Stratocaster® guitar (Fender Musical Instruments Corp., Scottsdale, AZ) introduced in 1954, as well as its newer and authorized replicas. Its simple construction has lent itself to wide customization. A goal of the solutions herein was to avoid disturbing its iconic look and feel of the guitar but to empower it far beyond the technology limitations available in 1954.

The parts map includes: Volume control 1601, Tone controls 1602, 5-way blade switch 1603, Bridge magnetic pickup, single-coil 1604, Middle magnetic pickup, single-coil 1605, Neck magnetic pickup, single-coil 1606, Mechanical vibrato arm 1607, Bridge and saddle piezoelectric pickups (piezos) 1608, and Jack plate 1609.

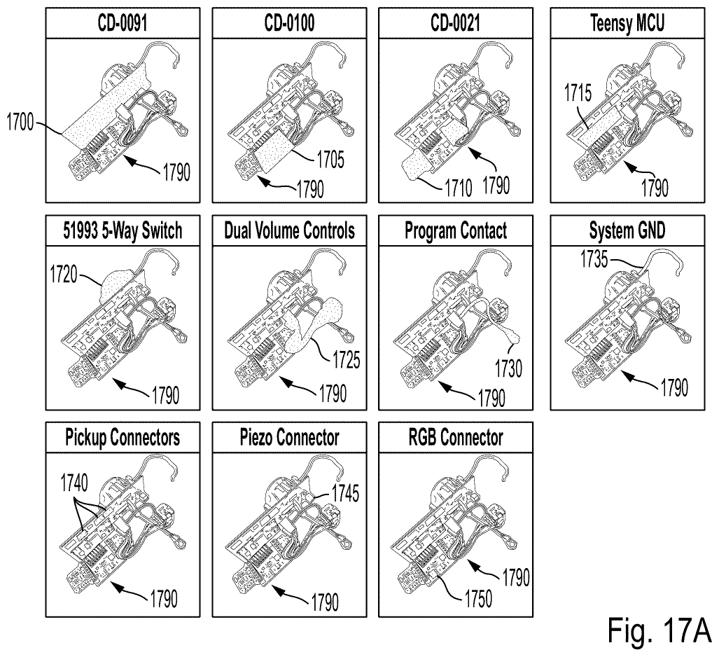

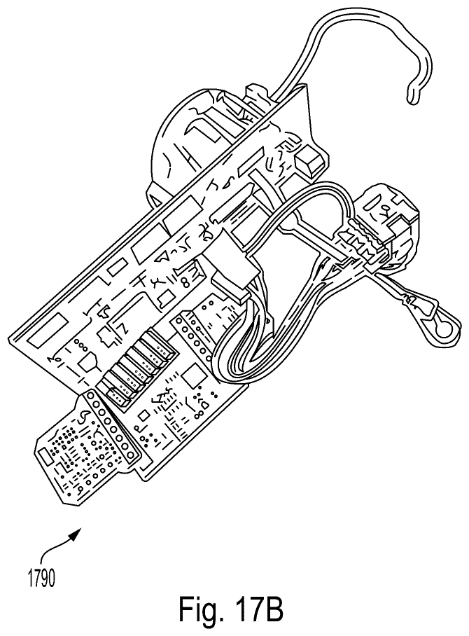

FIG. 17A depicts an example full module printed circuit board (PCB) and connector map, with different sections of the PCB 1790 noted by dotted regions, in accordance with various embodiments. The sections include the CD-0091 PCB 1700, the CD-0100 PCB 1705, the CD-0021 PCB 1710, the Teensy MCU 1715, the 51993 5-way switch 1720, the dual volume controls 1725, the program contact 1730, the system GND 1735, the pickup connectors 1740, the piezo connector 1745 and the RGB connector 1750.

The top row shows the positions of the four different circuit boards in a full board set. The second row shows the locations of the stock 5-way switch, an aftermarket dual volume control, and two important system connections: Ground, and external access to the Teensy 4.0 program logic input. The third row shows where the magnetic and piezo pickups connect to the CODEC, and where the connection to an optional external 3rd RGB LED can be found.

FIG. 17B depicts an example assembled functional module 1790 comprising a number of interconnected PCBs and third-party components, in accordance with various embodiments.

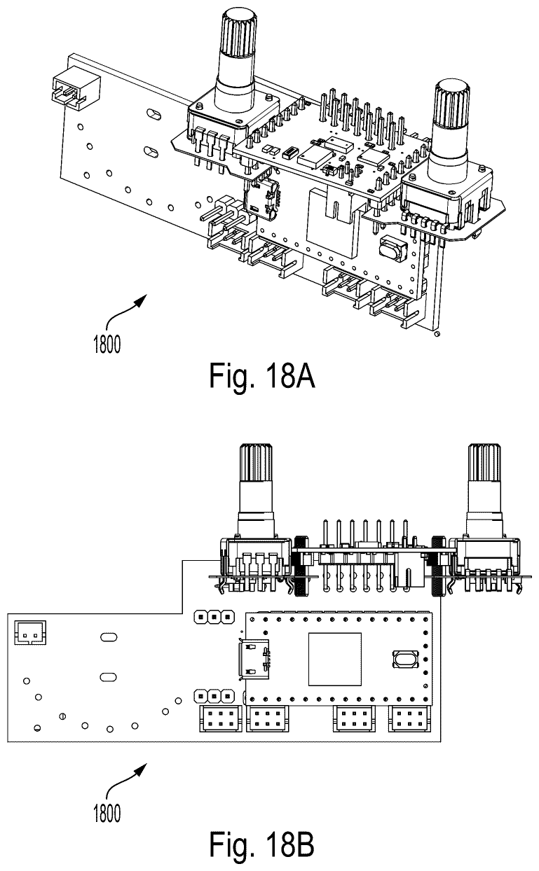

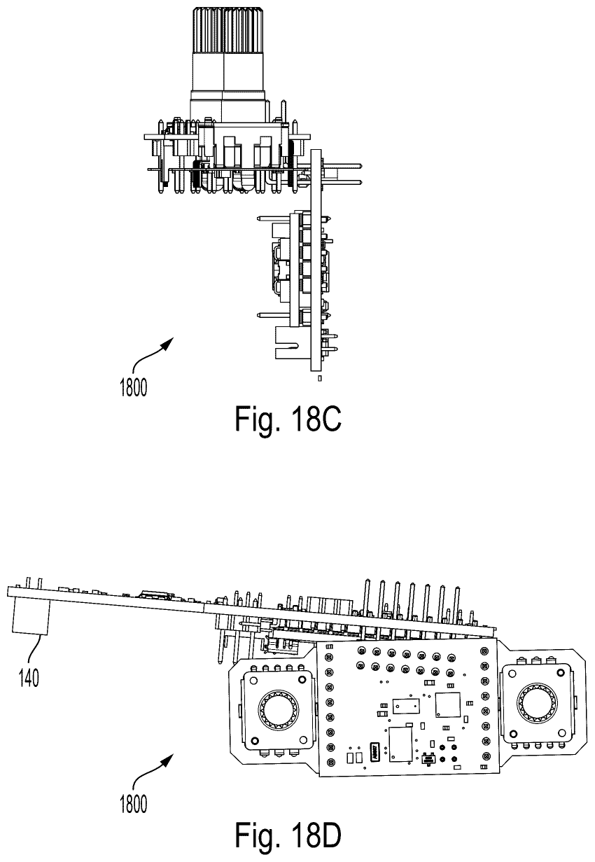

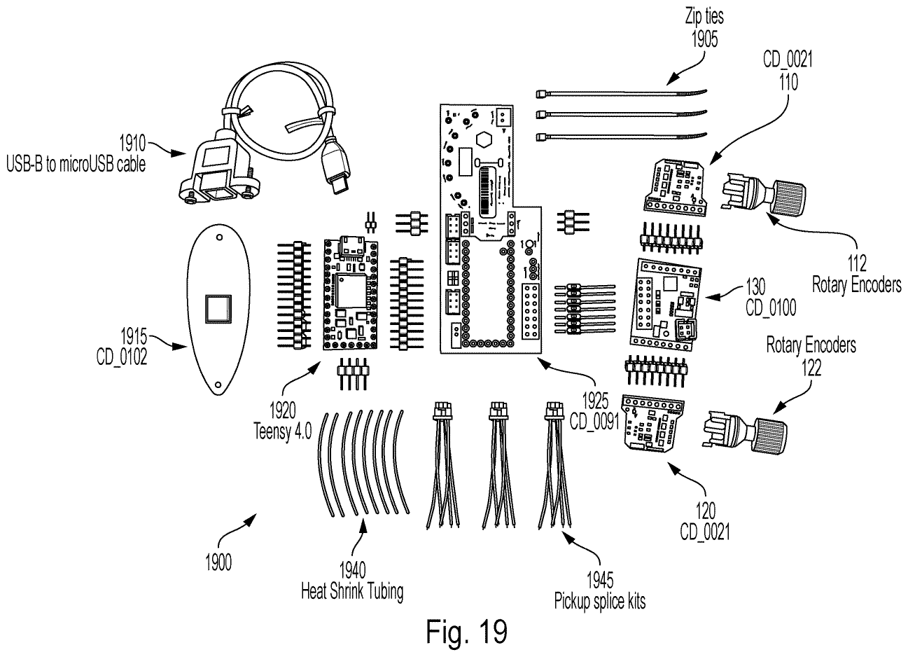

FIG. 18A depicts an example isometric view of an assembled functional module 1800 comprising a number of interconnected PCBs but without third-party components, in accordance with various embodiments.

FIG. 18B depicts an example side view of the module 1800 of FIG. 18A, in accordance with various embodiments.

FIG. 18C depicts an example end view of the module 1800 of FIG. 18A, in accordance with various embodiments.

FIG. 18D depicts an example top view of the module 1800 of FIG. 18A, in accordance with various embodiments.

FIGS. 18A-D include full stack orthographic and isometric drawings. Note that the leads are shown prior to being trimmed flush with the PCB surface. Also, notice the 6°angular cant of CD-0091 PCB in FIG. 18D, matching that of CD-0100 J1, allowing CD-0091 J6 to align with the 51993 2P5T switch contacts.

FIG. 19 depicts an example of PCBs in a kit 1900, including CD_0021, CD_0091, CD_0100, etc., in accordance with various embodiments. The figure depicts the full board set laid out with adjacent connectors clarifying how they link together (with solder joints). The kit includes Zip ties 1905, USB-B microUSB cable 1910, CD_0102 1915 (a USB jack plate compatible with the cable 1910), Teensy 4.0 daughterboard 1920, CD_0091 1925, Heat Shrink Tubing 1940, Pickup splice kits 1945, CD_0021 120, Rotary Encoders 112 and 122 and CD 0100 130.

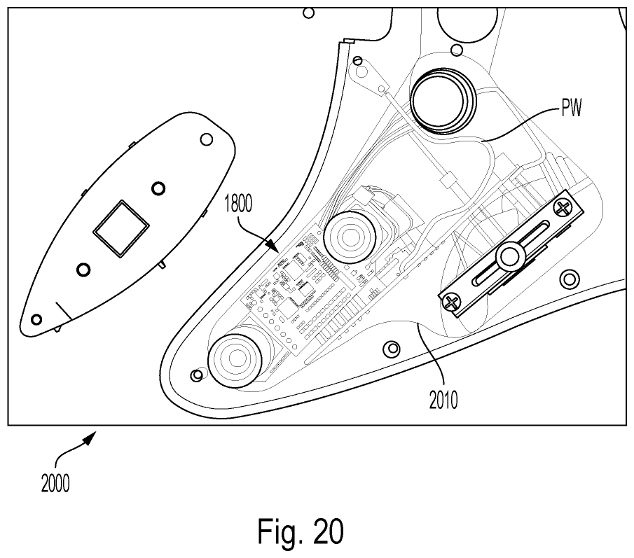

FIG. 20 depicts an example installation 2000 of the circuit 1800 described herein in a guitar body with a see-through pick guard 2010, in accordance with various embodiments. To add context, the full board set was installed on a clear pickguard and fitted into the control cavity route of a bare guitar body and aligned with screw holes. Note the white Program wire (PW) near its intended screw hole. The internal USB-B Female cable linking the custom USB jack plate with the Teensy 4.0 module is not shown.

FIG. 21 depicts an example portion of a guitar 2110 with a visual state indicator 2100, indicating a state of the circuit of FIG. 20, in accordance with various embodiments. Between the middle and neck pickups is a photo of a Flashing Tilefish (Hoplolatilus chlupatyi) wrapped around a plastic tube having an outside diameter equivalent to the width of the wiring channel. Inside this tube is an SMD RGB LED on a small PCB wired to the optional RGB LED connector of the CD-0100 PCB. The Tilefish can rapidly change color. The RGB LED of the CD-0100 PCB can mimic this behavior.

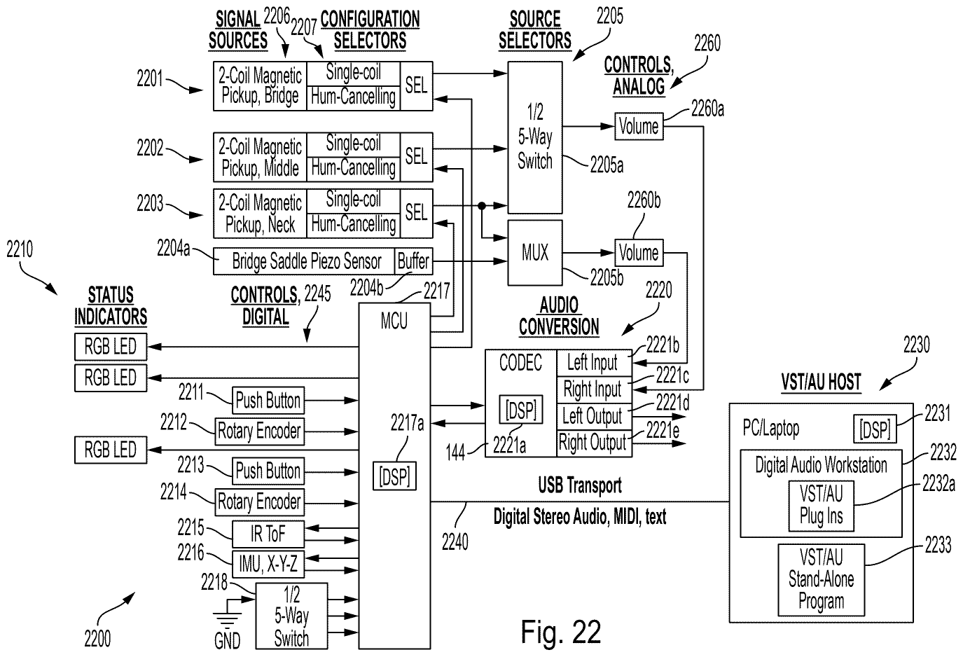

FIG. 22 depicts an example block diagram of a complete system 2200, in accordance with various embodiments. This drawing clearly classifies each part of the circuit as: Signal Sources 2206, Source Configuration Selectors, 2207 Source Selectors 2205, Analog Controls 2260, Status Indicators 2210, Digital Controls 2245, Audio Conversion circuits 2220 including and DSP Resources (Internal to the CODEC, Internal to the MCU, and External to, yet controlled by the circuit), and VST/AU Host 2230.

The bridge, middle and neck pickups 2201, 2202 and 2203, respectively, each include 2-coils which may be configured as either a single-coil or hum-cancelling. With an optional piezo bridge saddle pickup, a sensor 2204a and buffer 2204b can be provided.

The source selectors 2205 include a ½ 5-way switch 2205 a and a multiplexer (mux) 2205b.

The analog controls 2260 include volume controls 2260a and 2260b.

The status indicators 2210 include RGB LEDs controlled by an MCU 2217.

The digital controls include a MCU 2217 with a DSP 2217a. Inputs to the MCU include a push buttons 2211 and 2213, rotary encoders 2212 and 2214, an infrared (IR) ToF sensor 2215, an IMU 2216 and a ½ 5-way switch 2218.

The audio conversion circuits 2220 include the CODEC 144 with a DSP 2221a. The CODEC has left and right inputs 2221b and 2221c, respectively, and left and right outputs 2221d and 2221e, respectively.

The VST/AU Host 2230 is coupled to the MCU by a communication link 2240 for USB transport, digital stereo audio, MIDI and text. The VST/AU Host 2230 may be a PC or laptop, for example and includes a DSP 2231, a digital audio workstation 2232 with VST/AU plug ins 2232a and a VST/AU stand-alone program 2233.

The voice control variables can be provided using:
the 5-way switch position, 1 through 5
Left channel Mux: Neck pickup or piezo
Neck pickup configuration: single-coil or hum-cancelling
3 pickup configuration: Single-coil, hum-cancelling
S is the 5-Way switch position (1,2,3,4,5,0) (o: Right input channel Off),
M is the 1-bit 2-channel audio mux address (N: neck; P: Piezo; o: Left input channel Off),
PUC is the PickUp Configuration (S: Single coil, north hot; s: single coil, south hot; H: Hum-cancelling; o: Off),
L is the Left channel gain 100%
R is the Right channel gain 100%

In this example implementation, there are many unique permutations of the allowed combinations, or unique voices possible before adjusting the right/left blend, pan or DSP processing in the CODEC, MCU, or PC VST/AU plug-ins.

Features include the novel reimagination of half of the stock 51993 5-way switch as a digital control coupled with the Single-Coil/Humbucker Configuration Selectors linked by IP in the MCU. The recommended three dual-coil pickups can be configured as Vintage (Single-coil), Modern (Hum Cancelling), as an improved Hybrid combination, or “other” Blended voices. The stereo/mono controls are in the CODEC and MCU DSPs. An IR impulse response piezoelectric is also used.

Because the CODEC and MCU are both capable of merging or ignoring either of the stereo inputs, any signal source may be delivered to the USB payload as mono or stereo.

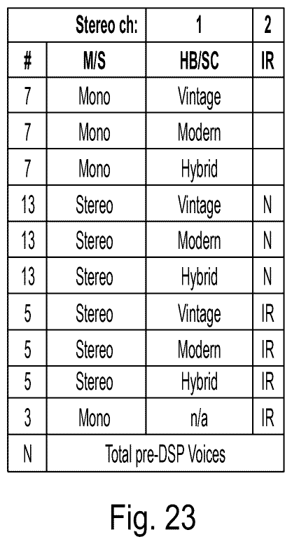

FIG. 23 depicts an example table of pre-DSP voices, in accordance with various embodiments.

Given the capacity of the MUX on the secondary input of the CODEC to choose between a copy of the neck pickup signal and the piezoelectric sensor, and that the neck pickup may be configured as a single-coil or hum-cancelling, there are many (e.g., a number N) voices possible given the permutations of those variables before the signal reaches one of the three DSP engines available in a complete system. The 18 marked as Impulse Response (IR) includes the piezo sensor output which may be processed like any other signal source but may also be convolved to any other pickup model.

Since Vintage (all pickups are configured as single-coil) Modern (all pickups are configured as hum-cancelling) and Hybrid (three of the 5-Way switch positions are Modern and two are Vintage) are predictably popular subsets of what is possible, there are many more voices possible that users may find musically useful outside the bounds of these few sets.

Some of the permutations contained logical contradictions given that the neck pickup can't be simultaneously both single-coil and hum-cancelling. The above analysis assumed the analog volume controls were either full on or full off. The volume blends and stereo mixes possible indicate the list of basic voices is far more exhaustive. The options that include the piezo allow for wide sonic remapping using commercial DSP Impulse Response algorithms. All the above can be post-processed with virtual pedal boards in the form of VST/AU plugins.

The Infrared (IR) Time-of-Flight (ToF) sensor measures the distance between the right-handed guitarist's right hand and the surface or the pickguard in real time. That number can be scaled and assigned to any controllable variable in the signal path. The number can be scaled to fit the range allowed by MIDI Continuous Controller message arguments, allowing it to manipulate any variable in the audio chain that receives MIDI CC messages.

The IMU (Inertial Measurement Unit) merges the outputs of a triaxial accelerometer, a triaxial gyroscope, & magnetometer using an (additional) embedded 32-bit ARM® Cortex™-M0+microcontroller (MCU) resulting in scalar outputs that can also be used to adjust audio controls in real-time. The IMU measures complex sensor orientation. The sketch (program or code) calculates pitch, roll, and yaw, and tailors them to the range allowed by MIDI Continuous Controller message arguments, allowing them to manipulate any variable in the audio chain that receives MIDI CC messages.

In view of the above, it can be seen that the solutions provided herein include a number of features including:
1. Instant Position Sensing (IPS™) of 51993 5-Way (2P5T) electric guitar pickup selection switch.
2. Method and apparatus of sensing change of 5-way switch position.
3. Method and algorithm of discrimination of 5-way switch static position.
4. Arbitrary Hum Control (AHC™) of 4c hum-cancelling magnetic electric guitar pickups.
5. MIDI over USB (MoU5E™) MIDI over USB by 5-throw switch Exploitation.
6. Method to Toggle the functionality of a 5-way switch from conventional to novel
7. Employment of RGB LED rotary encoders to control voicing parameters both within and external to the body of an electric guitar.

8. Use of embedded IMU device to instantly control live audio parameters of an electric guitar both within and external to the body of an electric guitar.
9. Use of embedded Distance Measuring device to instantly control live audio parameters both within and external to the body of an electric guitar.
10. Use of a signal multiplexer to select between a 3rd magnetic pickup and a bridge piezo sensor to the secondary stereo channel
11. Stereo digitization of multiple pickups and/or signal sensors within the body of an electric guitar.
12. Minimization of EMI radiation by limiting RGB color of controls and indicators to static logic levels: Black, Yellow, Green, Cyan. Blue, Magenta, Red, and White.

The solutions eliminate the 1950's era passive single-pole low-pass filters, also known as tone controls, replacing them with real-time software models of a wide variety of signal processing chains provided by the various DSP algorithms.

Some are easily accessible to the guitarist and may be quickly adjusted as they are attached to the body of the instrument ergonomically and located within reach.

The solutions herein leverage the convenient locations and familiarity of these controls as well as advancements in sensors, modern high-speed digitization, and high-speed numerical signal manipulation to provide a significantly wider range of tonal variations of voices and control options.

Advantageously, many existing widely popular electric guitars at a variety of price points can be retrofitted with this functionality without modification using basic soldering skills. Moreover, the solutions address a number of shortcomings of other approaches.

For example, regarding tone shaping in the guitar, the transfer function of the passive tone controls in a conventional electric guitar is typically limited to subtraction of the upper audio spectrum of the vibrating strings. Although the cutoff frequency is determined by the value of the passive capacitor and amount of resistance of the tone circuit's potentiometer, there is no gain or attenuation of the passband signal. No other poles or zeros exist to modify the shape of the spectrum.

In contrast, the parametric adjustments available to the transfer function of a digital filter offer a greater level of tonal variation than is possible with dedicated analog circuitry.

Some approaches may include a similar embedded electronic functionality, but fail in the marketplace for a variety of reasons, including:
The advanced circuitry was embedded in proprietary instruments with inflexible predetermined features.
They received poor reviews due to limited proprietary voice choices.
They received poor reviews due to fragile, unusual, or proprietary interface choices.
Unmarketable due to obsolete operating system dependency.
Unsustainable market price-point due to over-engineering.
Poor performance due to untimely battery depletion.
Market rejection due to unusual or unattractive esthetics.
Unusual proprietary user interfaces.

In contrast, the solutions provided herein offer superior options, including:
The guitar choice is personal with virtually unlimited options.
The voice choices are personal with virtually unlimited options.
The USB-B connector is more robust than the fragile and smaller connectors found in competing USB electric guitars.
The USB interface is compatible with virtually every modern operating system.
The circuit design is elegant and not inordinately complex.
There is no battery to run down in the middle of a performance.
The controls are in the same locations and operate the same way as conventional controls.

Regarding tone shaping external to the guitar, a variety of external signal processing devices can be used to add additional voice customization, including:
A variety of stand-alone analog or digital effects units have footswitches to enable them and knobs to control transfer function variables. They are powered by internal batteries or external AC-DC converters.
Integrated analog or digital effects units with more sophisticated architecture, e.g., reordering the sequence (i.e., the effects chain) or combinations of effects. These are typically encased in larger industrial packages with a shared power supply.
Thousands of software model plug-ins running on general purpose computing platforms share common protocols: VST (Steinberg's Virtual Studio Technology) and AU (Apple's Audio Unit).

Their known disadvantages include:
Manual controls, if they exist, are often not easily accessible as they are not located on the body of a conventional guitar, but in the worst case, on a poorly illuminated floor. o The signal chains of these stand-alone daisy-chained processing elements are for all practical purposes fixed and inflexible.
The cost of a fully populated and properly organized pedalboard would include a bulky framework.
Multiple required cables and unsoldered mating joints introduce many possible connectivity failure modes.
A separate durable container is typically required to protect the fragile controls during transportation.
Control of these systems are enabled, disabled, or changed using foot switches and/or variable pedals, contributing to stage clutter.
They are universally bulky to transport between rehearsal spaces, recording studios, and performance venues.

Regarding noise control internal to the guitar, many guitar pickups only have a single coil which can be adversely affected by local 60 Hz electromagnetic hum. This problem has been simultaneously and independently addressed in 1955 by Seth Lover at Gibson Inc., (Nashville, TN) and Ray Butts at Gretsch Co. (Savannah, GA) (Filter'Tron®) by pickups having two complementarily wired coils which cancel this undesirable hum.

In the case of electric guitars having three hum-sensitive single coil pickups, e.g., the ideal model the solutions herein targets, two of five positions of a 5-way pickup selector also cancel this noise if the middle pickup coil has complementary wiring with both other single-coil pickups. The other three positions remain susceptible to hum.

One approach to improving the noise performance of single-coil pickups is concealing a second coil in the same size package. The second coil is typically wired in series with the first which increases its impedance and its corresponding output level. This is necessary because the 5-way switch combines adjacent pickups in parallel which reduces the combined output levels. Four coils in parallel would be an extreme contrast with two coils wired in series, which is the description of a single hum-cancelling pickup.

The voice of a single coil pickup is distinct from a dual coil hum-cancelling pickup. Also, two complementary single coil pickups combining harmonics located at different regions of a vibrating string have a uniquely different voice than two complementary coils sampling the same string region. That voice difference may be a major factor in the success of those models and efforts to improve the noise using stacked dual coil noise-cancelling pickups may do so at the expense of their success.

The solutions herein allows the user with basic programming skills to define their own pickup wiring choices for every chosen 3rd party voice and 5-way blade switch position. They don't need to choose between the classic success voices and those that have reduced hum.

One solution to this problem replaces the conventional 2-pole 5-throw switch with a more complex 4-pole 5-throw switch resulting in very convoluted wiring.

In contrast, the solutions herein repurpose half of the original 51993 2-pole 5-throw switch to solve the same problem, adding contextual flexibility lacking in that hard-wired solution.

The solutions herein uniquely avoid the above-mentioned defects by:
Allowing the user to transform an instrument that already possesses the users' desirable features, e.g., body, neck, fingerboard, and fret wire materials (or lack thereof), neck profile and radius, scale length, and esthetics finishes.
Allowing the user to select, organize, and associate their chosen 3rd party voices with specific control states, and improve them as more desirable options become available.
Allowing the user to obtain only the desirable transformative features at a significantly reduced cost
Allowing the user to leverage the economy of using their own soldering skills or owned instrument optimizes affordability.
Selecting a ubiquitous interface widely supported worldwide with complementary 3^{rd} party products.

Regarding the technology used, the solutions herein apply newer technology to extend the range of tonal variations with controls that operate in a similar manner to the conventional ones. These newer technologies include:
Multilayer circuit boards with surface mount devices (SMDs) enable the miniaturization of the circuitry.
A high-performance embedded microcontroller senses the dynamic and static states of the human interface controls.
Innovative circuitry and elegant software repurposed half of the stock 51993 5-way switch as a digital control element.
The embedded program determines contextual actions, either locally or in connected computer equipment.
A simple circuit can reconfigure certain aftermarket magnetic pickups as either single-coil or hum-cancelling.
Support is included for non-magnetic piezoelectric signal sensors mounted under the bridge saddle. The ARM Cortex M7 processor in this embodiment is more powerful than the M4 that has been shown to run code emulating magnetic pickups noiselessly.
Circuit options allow for selection, either fixed or under program control, of the piezo signal or the neck pickup.
A stereo CODEC digitizes the selected pickup on one channel and the neck or piezo on the other.
The two digitized signals may be mixed, routed, or digitally processed within the embedded microcontroller resulting in similar voices possible with conventional external processing implementations, under user-defined signal chains.
MIDI commands can be issued to connected computer equipment resulting in drastically different instrument voices.
The digitized stereo signal and MIDI messages are combined into a single USB payload in the microcontroller and delivered to an external processing device over a standard USB cable.
The entire invention was tailored to fit into the control cavity of a specific popular electric guitar model, the Stratocaster®, without disturbing the iconic appearance of that ubiquitous instrument.
The pairing of the solutions herein with commercially available compact laptop computers running 3^{rd} party VST and/or AU software models results in a total solution that can fit in a typical guitar gig bag yet with the advantage of rapid fingertip selection of a vast library of user-curated 3^{rd} party voices.

The only requirement for external equipment beyond a USB-equipped computer is that it must also have a separate audio output device if the signal is intended to be used live. This audio output device may be as simple, compact, and lightweight as XLR links to a sound system with wireless in-ear monitors or may simply be a second identical unit less the 5-way switch, running a simpler set of instructions, mounted in an external enclosure with added line out and headphone connections.
A miniature Arduino class microcontroller hosts the software that allows the similarly operated controls to accomplish far more than originally intended. The knobs on conventional guitars are potentiometers. Here, they've been replaced with rotary knobs with integral or associated RGB LEDs to serve as state indicators, and momentary contact pushbuttons to assert additional effect changes.
Hardware interrupts are used extensively to service changes in each human interface input control.
Two kinds of motion sensors are included for optional special control:
   a. A 9-degree of freedom (9DoF) Inertial Measurement Unit (IMU) integrating a magnetometer. accelerometer, gyroscope, and ARM M0 RISC.
   b. A Time of Flight (ToF) Infrared (IR) rangefinder which could function as an invisible replacement for or supplement to the problematic mechanical vibrato bar but with increased flexibility to control effects other than pitch shifting.
A third RGB LED is supported for additional program status indication.
The common electric guitar uses a 2 pole-5-throw switch to select combinations of three pickups and up to two passive tone controls. The solutions herein replaces two knobs (typically tone controls) with rotary encoders. The half of the 51993 5-way switch is repurposed with a novel hardware and software method of determining when it moves and where it stops.

In sum, the primary problem the solutions herein intended to solve was the elimination of a large, heavy MIDI footswitch. Additional improvements precipitated during the development of the implementation include:
Promotion of the 5-way switch from simple harmonic tone control to:
   reconfiguring magnetic pickups from single-coil to hum-cancelling
   address internal DSP voice presets in the CODEC and/or MCU
   address and combine entire external 3^{rd} party virtual pedal boards and environmental acoustics using MIDI Program Change messages.
Promotion of the passive tone controls to virtually anything controls, e.g.,
   Sending MIDI Continuous Controller messages.
   Toggling Boolean variables
   Selecting from a list of predetermined behaviors
   Selecting kinds (genres) and/or variants of presets
The addition of motion sensors to dynamically control tonal parameters.
The use of colored LEDs as state indicators to manage the increased range of functionality.

The following abbreviations and acronyms are used.

| Acronym | Definition |
|---|---|
| 2P5T | Two Pole-Five Throw |
| 4C | Four Conductor (5, including GND drain wire) |
| 4P5T | Four Pole-Five Throw |
| 9DoF | Nine Degree of Freedom |
| AHC ™ | Arbitrary Hum Control ™ |
| ARM | Advanced Reduced Instruction |
| | Set Computer (RISC) Machine |
| AU | Audio Unit (Apple Inc.) |
| C | Capacitor |
| CCW | Counter-Clockwise |
| CODEC | Coder-Decoder |
| CW | Clockwise |
| DAW | Digital Audio Workstation |
| DSP | Digital Signal Processing |
| EMI | Electromagnetic Interference |
| EQ | Equalizer/Equalization |
| GND | Ground |
| GPIO | General Purpose Input-Output |
| HB | Hum Bucker |
| HC | Hum-Cancelling |
| I2S | Inter-Integrated circuit Sound |
| IC | Integrated Circuit |
| IMU | Inertial Measurement Unit |
| IPS ™ | Instant Position Sensing ™ |
| IR | Infra-Red (Light Time-of-flight (ToF) sensor context) |
| IR | Impulse Response (audio signal context) |
| ISR | Interrupt Service Routine |
| LED | Light-Emitting Diode |
| LPF | Low-Pass Filter |
| MCU | Microcontroller Unit |
| MIDI | Musical Instrument Digital Interface |
| MoU5E ™ | MIDI over USB by 5-way Switch Exploitation |
| MVP | Minimal Viable Product |
| PCB | Printed Circuit Board |
| PCM | Pulse Code Modulated |
| R | Resistor |
| RC | Resistor-Capacitor |
| RGB | Red Green Blue |
| RISC | Reduced Instruction Set Computer |
| SC | Single-coil |
| SFSM | Sequential Finite State Machine |
| SMD | Surface Mount Device |

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. An apparatus, comprising:
a stereo coder/decoder (CODEC) configured to be coupled to a multi-position switch for magnetic pickups of a guitar;
a microcontroller unit (MCU) coupled to the CODEC and to the multi-position switch; and
a rotary encoder coupled to the MCU, wherein the MCU is configured to communicate with an external host computer via a Music Instrument Digital Interface (MIDI) protocol based on the multi-position switch and the rotary encoder.

2. The apparatus of claim 1, further comprising a pushbutton coupled to the MCU, where the pushbutton is configured to toggle a Music Instrument Digital Interface (MIDI) Enable control bit.

3. The apparatus of claim 1, wherein the multi-position switch is a five-way blade switch.

4. The apparatus of claim 1, further comprising a Universal Serial Bus (USB) link to couple the MCU to the host computer.

5. The apparatus of claim 1, wherein the rotary encoder is configured to be coupled to a control knob of the guitar.

6. The apparatus of claim 1, wherein the rotary encoder is configured to initiate an interrupt when rotated.

7. The apparatus of claim 1, wherein the rotary encoder is configured to initiate a Music Instrument Digital Interface (MIDI) operational code (opcode) when rotated, and the opcode is based on whether the rotary encoder is rotated clockwise or counterclockwise.

8. The apparatus of claim 1, wherein the CODEC is configured to be coupled to a bridge saddle piezoelectric sensor of the guitar.

9. The apparatus of claim 1, wherein:
the magnetic pickups comprise three two-coil, four conductor magnetic pickups;
the apparatus further comprising a selector coupled to the MCU and to one or more of the two-coil magnetic pickups; and
the selector is configured to change configure-any combination of the three two-coil, four conductor magnetic pickups from hum-cancelling to single coil.

10. The apparatus of claim 1, wherein the MCU comprises a Universal Serial Bus (USB)-based microcontroller development system.

11. The apparatus of claim 1, wherein one or more inputs of the CODEC are configured to be coupled to one or more outputs of the multi-position switch via one or more volume potentiometers.

12. The apparatus of claim 1, wherein the rotary encoder is configured to cause the MCU to select a Music Instrument Digital Interface (MIDI) Program Change message.

13. The apparatus of claim 1, wherein the MCU is configured to select a Music Instrument Digital Interface (MIDI) Program Change message based on a position of the multi-position switch.

14. The apparatus of claim 1, wherein the rotary encoder comprises a visual indicator configured to indicate a state of the apparatus.

15. The apparatus of claim 1, wherein the MCU comprises a library of Music Instrument Digital Interface (MIDI) messages.

16. The apparatus of claim 1, wherein the CODEC, MCU and rotary encoder are on one or more printed circuit boards (PCBs) in a body of the guitar.

17. The apparatus of claim 1, further comprising a motion sensor coupled to the MCU, wherein the motion sensor comprises at least one of an IMU (Inertial Measurement Unit) sensor or a ToF (Time of Flight) sensor.

18. A guitar body, comprising:
a plurality of magnetic pickups;
a multi-position blade switch coupled to the plurality of magnetic pickups;
one or more control knobs; and
one or more printed circuit boards (PCBs), wherein the one or more PCBs comprise a stereo coder/decoder (CODEC) coupled to the multi-position blade switch, a microcontroller unit (MCU) coupled to the CODEC and to the multi-position blade switch, and a rotary encoder coupled to the MCU and to the one or more control knobs, wherein the MCU is configured to communicate with an external host computer based on the multi-position blade switch and the rotary encoder.

19. The guitar body of claim 18, further comprising a pushbutton coupled to the MCU, where the pushbutton is configured to toggle a Music Instrument Digital Interface (MIDI) Enable control bit.

20. The guitar body of claim 18, wherein the rotary encoder is configured to cause the MCU to select a Music Instrument Digital Interface (MIDI) Program Change message.

21. The guitar body of claim 18, wherein the MCU is configured to select a Music Instrument Digital Interface (MIDI) Program Change message based on a position of the multi-position blade switch.
